(19) United States
(12) Patent Application Publication
(10) Pub. No.: US 2025/0265879 A1
(43) Pub. Date: Aug. 21, 2025

(54) OPENING/CLOSING CONTROL SYSTEM, OPENING/CLOSING DEVICE, AND OPENING/CLOSING CONTROL METHOD

(71) Applicant: Mitsubishi Electric Corporation, Tokyo (JP)

(72) Inventors: Mieko ARITA, Tokyo (JP); Mio OKADA, Tokyo (JP); Junji OTANI, Tokyo (JP)

(73) Assignee: Mitsubishi Electric Corporation, Tokyo (JP)

(21) Appl. No.: 18/992,520

(22) PCT Filed: Mar. 8, 2023
(86) PCT No.: PCT/JP2023/008710

§ 371 Date: Jan. 8, 2025

(51) Int. Cl. G07C 9/00; G07C 9/10; G08B 21/24

(52) U.S. Cl. CPC G07C 9/00563; G07C 9/10; G08B 21/24

(57) ABSTRACT

An opening/closing control system is an opening/closing control system that controls opening/closing of an opening/closing target and includes a recognition unit that recognizes an opening/closing person who performs an opening/closing action on the opening/closing target, an output control unit that performs output control to output notification content to the opening/closing person according to the opening/closing person recognized by the recognition unit, and a lock control unit that performs lock control to control unlocking or locking of the opening/closing target according to the opening/closing person recognized by the recognition unit.

### TECHNICAL FIELD

The present disclosure relates to an opening/closing control system, an opening/closing device, and an opening/closing control method.

### BACKGROUND ART

In recent years, a system has become known that provides information such as advice and warnings to users who are opening/closing persons who perform opening/closing actions, such as those who put things in and take things out, or those who allow users to enter and exit, for example, from the viewpoint of education and danger avoidance (see, for example, Patent Document 1).

### CITATION LIST

### Patent Document

Patent Document 1: Japanese Unexamined Patent Application, First Publication No. 2004-78304

### SUMMARY OF INVENTION

### Technical Problem

However, in the above-mentioned system in the related art, information such as advice and warnings is provided to the opening/closing person who performs the opening/closing action, and it is difficult to appropriately manage the opening/closing action of the opening/closing person.

The present disclosure has been made to solve the above problem, and an object of the present disclosure is to provide an opening/closing control system, an opening/closing device, and an opening/closing control method that can appropriately manage an opening/closing action of an opening/closing person while providing information according to the opening/closing person who performs the opening/closing action.

### Solution to Problem

In order to solve the above problems, according to one aspect of the present disclosure, an opening/closing control system is provided that controls opening/closing of an opening/closing target, the opening/closing control system including: a recognition unit to recognize an opening/closing person who performs an opening/closing action on the opening/closing target; an output control unit to perform output control to output notification content to the opening/closing person according to the opening/closing person recognized by the recognition unit; and a lock control unit to perform lock control to control unlocking or locking of the opening/closing target according to the opening/closing person recognized by the recognition unit.

According to another aspect of the present disclosure, an opening/closing device is provided that controls opening/closing of an opening/closing target, the opening/closing device including: a recognition unit to recognize an opening/closing person who performs an opening/closing action on the opening/closing target; an output control unit to perform output control to output notification content to the opening/closing person according to the opening/closing person recognized by the recognition unit; and a lock control unit to perform lock control to control unlocking or locking of the opening/closing target according to the opening/closing person recognized by the recognition unit.

According to still another aspect of the present disclosure, an opening/closing control method for an opening/closing control system is provided that controls opening/closing of an opening/closing target, the opening/closing control method including: recognizing, by a recognition unit, an opening/closing person who performs an opening/closing action on the opening/closing target; performing, by an output control unit, output control to output notification content to the opening/closing person according to the opening/closing person recognized by the recognition unit; and performing, by a lock control unit, lock control to control unlocking or locking of the opening/closing target according to the opening/closing person recognized by the recognition unit.

### Advantageous Effects of Invention

According to the present disclosure, it is possible to appropriately manage an opening/closing action of an opening/closing person while providing information according to the opening/closing person who performs the opening/closing action.

### BRIEF DESCRIPTION OF DRAWINGS

FIG. 1 is an image diagram showing an overview of an opening/closing control system according to the present embodiment.

FIG. 2 is a diagram showing an example of installation of an electronic lock in the opening/closing control system according to the present embodiment.

FIG. 3 is a diagram showing an example of a structure of an electronic lock according to the present embodiment.

FIG. 4 is a block diagram showing an example of an electronic lock according to the present embodiment.

FIG. 5 is a first diagram showing an example of data in a scenario storage unit according to the present embodiment.

FIG. 6 is a second diagram showing an example of data in the scenario storage unit according to the present embodiment.

FIG. 7 is a flowchart showing an example of an operation of the electronic lock according to the present embodiment.

FIG. 8 is an image diagram showing an overview of additional services of the opening/closing control system according to the present embodiment.

FIG. 9 is a configuration diagram showing an example of the opening/closing control system according to the present embodiment.

FIG. 10 is a block diagram showing an example of a mobile terminal according to the present embodiment.

FIG. 11 is a diagram showing an example of data in a user information storage unit according to the present embodiment.

FIG. 12 is a diagram showing an example of data of target person setting information in a lock setting storage unit according to the present embodiment.

FIG. 13 is a diagram showing an example of data of lock setting information in the lock setting storage unit according to the present embodiment.

FIG. 14 is a diagram showing an example of data of scenario setting information in the lock setting storage unit according to the present embodiment.

FIG. 15 is a diagram showing an example of data in a lock log storage unit according to the present embodiment.

FIG. 16 is a diagram showing an example of a screen display for lock setting of the opening/closing control system according to the present embodiment.

FIG. 17 is a block diagram showing an example of an application server according to the present embodiment.

FIG. 18 is a block diagram showing an example of an SNS server according to the present embodiment.

FIG. 19 is a block diagram showing an example of a distribution server according to the present embodiment.

FIG. 20 is a first diagram showing an example of data in a distribution information storage unit according to the present embodiment.

FIG. 21 is a second diagram showing an example of data in the distribution information storage unit according to the present embodiment.

FIG. 22 is a diagram showing an example of a screen display in a distribution process of the opening/closing control system according to the present embodiment.

FIG. 23 is a block diagram showing an example of a management server according to the present embodiment.

FIG. 24 is a diagram showing an example of an operation of the opening/closing control system according to the present embodiment.

FIG. 25 is a diagram showing an example of a learning process of the opening/closing control system according to the present embodiment.

FIG. 26 is an explanatory diagram showing a hardware configuration of each device in the opening/closing control system according to the present embodiment.

### DESCRIPTION OF EMBODIMENTS

An opening/closing control system, an opening/closing device, and an opening/closing control method according to an embodiment of the present disclosure will be described below with reference to the drawings.

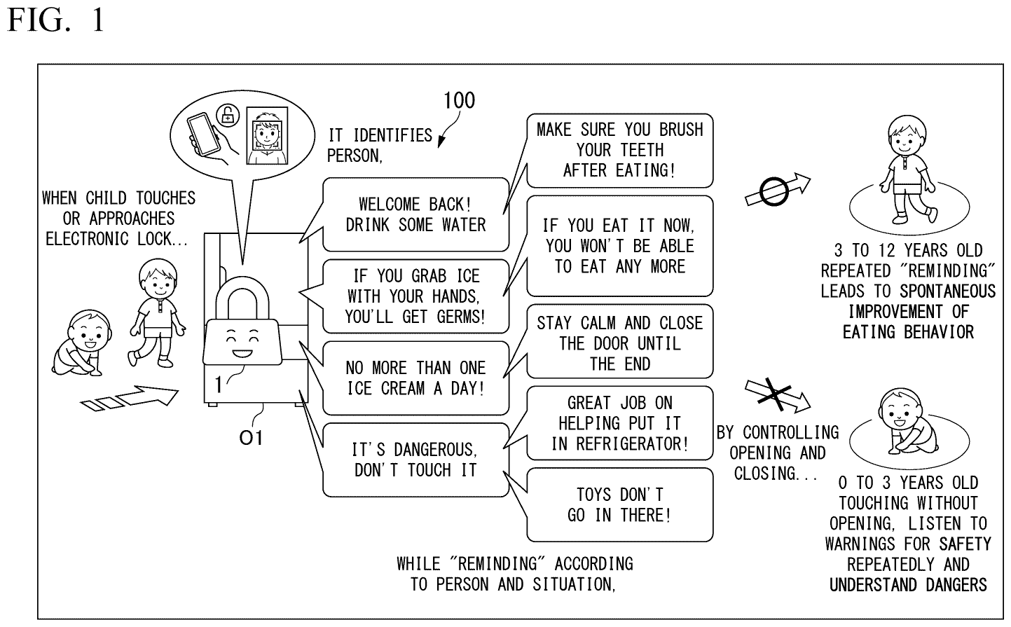

FIG. 1 is an image diagram showing an overview of an opening/closing control system 100 according to the present embodiment.

As shown in FIG. 1, in the opening/closing control system 100 according to the present embodiment, an electronic lock 1 is installed on an opening/closing target, such as a refrigerator O1, and in a case where the electronic lock 1 recognizes an opening/closing person who performs an opening/closing action on the opening/closing target, it outputs notification content for various types of “reminding” (for example, spoken content) according to the opening/closing person. In addition, the electronic lock 1 controls the locking or unlocking of the electronic lock 1 according to the opening/closing person.

Note that “outputting the notification content” includes outputting by voice, display, light, and the like.

The opening/closing control system 100 outputs notification content from the viewpoint of, for example, education, danger avoidance, behavioral restraint, and support, and also controls the locking or unlocking of the electronic lock 1. Here, the term “education” refers to a case in which desirable behavior related to the opening/closing target is notified, regardless of whether the electronic lock 1 is locked or unlocked, for example. Alternatively, “education” refers to a case in which desirable behavior related to the opening/closing target or the contents of the opening/closing target is notified, regardless of whether the electronic lock 1 is locked or unlocked, for example.

In addition, “danger avoidance” refers to a case in which the electronic lock 1 is forcibly locked, mainly for children, because the opening/closing action may cause danger.

In addition, “behavioral restraint” refers to a case in which the electronic lock 1 is forcibly locked, mainly for adults, for health reasons and the like. Furthermore, “support” refers to a case in which a notification that provides assistance or support is output for education, danger avoidance, behavioral restraint, and the like.

For example, in a case where a child between 0 and 3 years of age approaches the refrigerator O1, the opening/closing control system 100 outputs a notification such as “It's dangerous, don't touch it”, and forcibly locks electronic lock 1. This prevents the child from opening the refrigerator O1 and allows the child to understand the danger by repeatedly listening to the warning.

Also, for example, in a case where a child between 3 and 12 years of age approaches the refrigerator O1, the opening/closing control system 100 outputs a notification such as “No more than one ice cream a day!” or “If you eat it now, you won't be able to eat any more”, and does not forcibly lock the electronic lock 1. This allows children to listen to repeated “reminding” and encourages them to improve their eating behavior voluntarily.

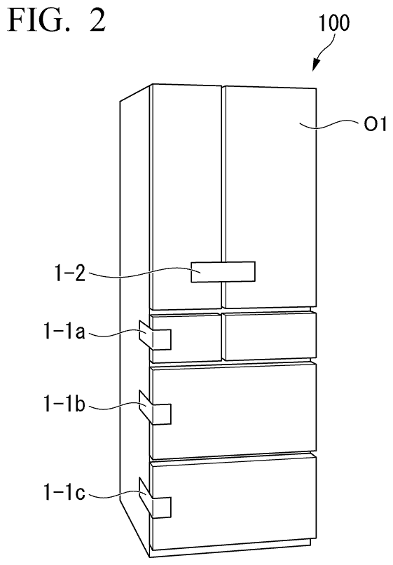

Next, an example of installation of the electronic lock 1 of the opening/closing control system 100 according to the present embodiment will be described with reference to FIG. 2.

FIG. 2 is a diagram showing an example of installation of the electronic lock 1 of the opening/closing control system 100 according to the present embodiment.

In the example shown in FIG. 2, electronic locks 1 (1-1a to 1-1c, and 1-2) are installed at each opening/closing location of a refrigerator O1.

The electronic lock 1-1a, the electronic lock 1-1b, and the electronic lock 1-1c are installed at opening/closing locations of drawers such as a vegetable compartment, a freezer compartment, and an ice compartment of the refrigerator O1 and control the opening/closing (locking or unlocking) of these opening/closing locations.

Moreover, the electronic lock 1-2 is installed on the main door of the refrigerator O1 and controls the opening/closing (locking or unlocking) of the door.

In the present embodiment, the electronic lock 1-1a, the electronic lock 1-1b, the electronic lock 1-1c, and the electronic lock 1-2 will each be described as the electronic lock 1 in a case where referring to any electronic lock provided in the opening/closing control system 100 or in a case where no particular distinction is made between them.

Furthermore, the electronic lock 1-1a, the electronic lock 1-1b, and the electronic lock 1-1c have the same configuration, and in a case where there is no need to distinguish between their installation locations, they will be described as an electronic lock 1-1.

The electronic lock 1 is also an example of an opening/closing device that controls the opening/closing of an opening/closing target (for example, the refrigerator O1). The opening/closing target is not limited to the refrigerator O1, but may be any opening/closing location of a home appliance, furniture, home equipment (for example, windows, doors), room, store, and the like. Furthermore, the electronic lock 1 is configured to be attachable and detachable to and from the opening/closing target (for example, the refrigerator O1).

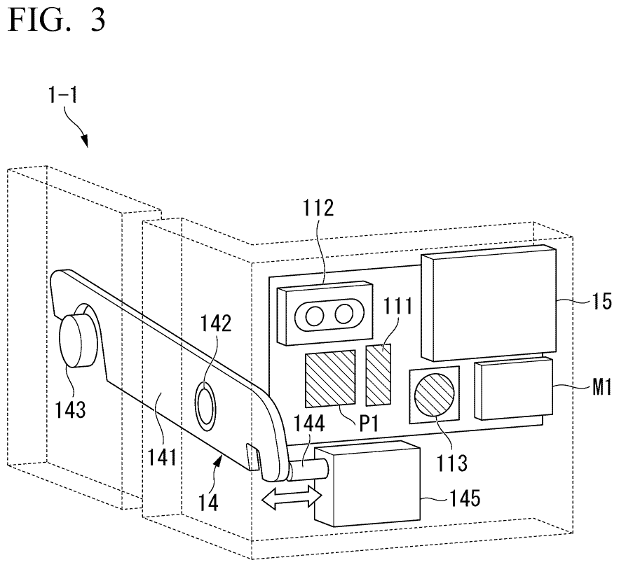

Next, the configuration of the electronic lock 1 will be described with reference to FIG. 3.

FIG. 3 is a diagram showing an example of a structure of the electronic lock 1 according to the present embodiment. As an example, the configuration and locking mechanism of an electronic lock 1-1 will be described with reference to FIG. 3.

As shown in FIG. 3, the electronic lock 1-1 includes a lock unit 14, a power supply 15, a communication unit 111, an imaging unit 112, an output unit 113, a processor P1, and a memory M1.

The lock unit 14 is a locking mechanism that opens and closes (locks or unlocks) the electronic lock 1-1. The lock unit 14 includes a plate 141, a rotating shaft 142, a protrusion 143, a lock bolt 144, and a drive unit 145.

The plate 141 is a metal plate that can be rotated by the rotating shaft 142, and is fixed by the protrusion 143 in a case where the opening/closing target is closed. Furthermore, the plate 141 rotates around the rotating shaft 142 to come off the protrusion 143, making it possible to open the opening/closing target.

Furthermore, the plate 141 is in a rotatable state in a case where the electronic lock 1-1 is in an unlocked state and is in a non-rotatable state by the lock bolt 144 in a case where the electronic lock 1-1 is in a locked state.

The lock bolt 144 is driven by the drive unit 145, and in a case where the electronic lock 1-1 is in the locked state, fixes the plate 141 to make it unrotatable.

Furthermore, in a case where the electronic lock 1-1 is in an unlocked state, the lock bolt 144 releases the plate 141 from its fixed position to make it rotatable.

The drive unit 145 is composed of, for example, an actuator and drives the lock bolt 144 under the control of a processor P1, which will be described later.

The power supply 15 is, for example, a battery, and supplies power to each part of the electronic lock 1-1. The power supply 15 is configured to be attachable and detachable, and the electronic lock 1-1 is configured to be in an unlocked state during battery replacement (while no power is being supplied).

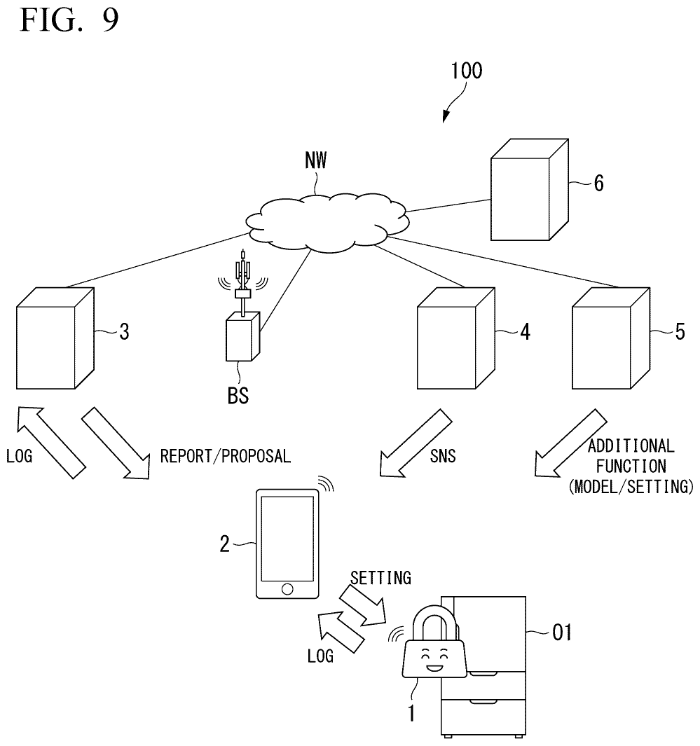

The communication unit 111 is, for example, a communication module such as a wireless local area network (LAN) or Bluetooth (registered trademark). The communication unit 111 communicates with a mobile terminal 2 (FIG. 9) which will be described later.

The imaging unit 112 is, for example, a camera having a charge-coupled device (CCD) image sensor or the like. The imaging unit 112 performs imaging for recognizing the opening/closing person.

The output unit 113 is, for example, a speaker and outputs various voices including notification content.

The processor P1 is a processing circuit including a central processing unit (CPU), for example. The processor P1 executes various processes of the electronic lock 1-1 by executing programs stored in a built-in memory (not shown) or in the memory M1.

The memory M1 is, for example, a storage device such as a RAM, a flash memory, or an HDD and stores various types of information and programs used by the electronic lock 1-1. The memory M1 may be an attachable and detachable flash memory card.

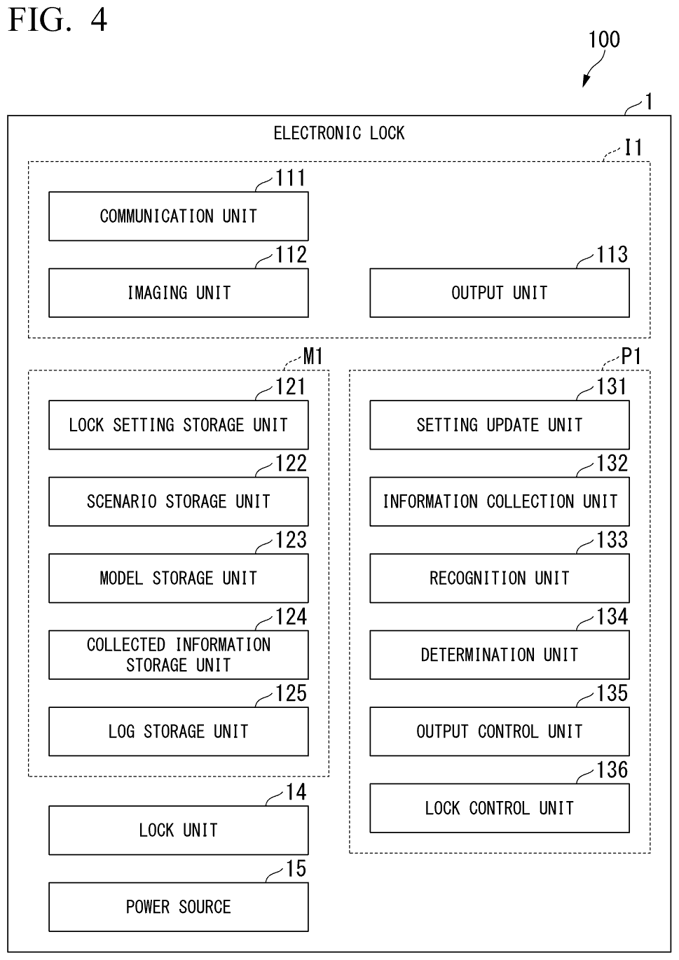

Next, the functional configuration of the electronic lock 1 according to the present embodiment will be described with reference to FIG. 4.

FIG. 4 is a block diagram showing an example of the electronic lock 1 according to the present embodiment.

As shown in FIG. 4, the electronic lock 1 of the opening/closing control system 100 according to the present embodiment includes a lock unit 14, a power supply 15, a communication unit 111, an imaging unit 112, an output unit 113, a lock setting storage unit 121, a scenario storage unit 122, a model storage unit 123, a collected information storage unit 124, a log storage unit 125, a setting update unit 131, an information collection unit 132, a recognition unit 133, a determination unit 134, an output control unit 135, and a lock control unit 136.

The configurations of the lock unit 14, the power supply 15, the communication unit 111, the imaging unit 112, and the output unit 113 have been described with reference to FIG. 3 above, and therefore description thereof will be omitted here. The power supply 15, the communication unit 111, the imaging unit 112, and the output unit 113 are included in an input/output module 11.

In addition, the lock setting storage unit 121, the scenario storage unit 122, the model storage unit 123, the collected information storage unit 124, and the log storage unit 125 are storage units realized by the above-mentioned memory M1.

The lock setting storage unit 121 stores setting information of the electronic lock 1. The lock setting storage unit 121 stores, for example, setting information for the electronic lock 1, such as the set scenario information, the target person information for the opening/closing person, and information on the opening/closing target which is a target to be locked.

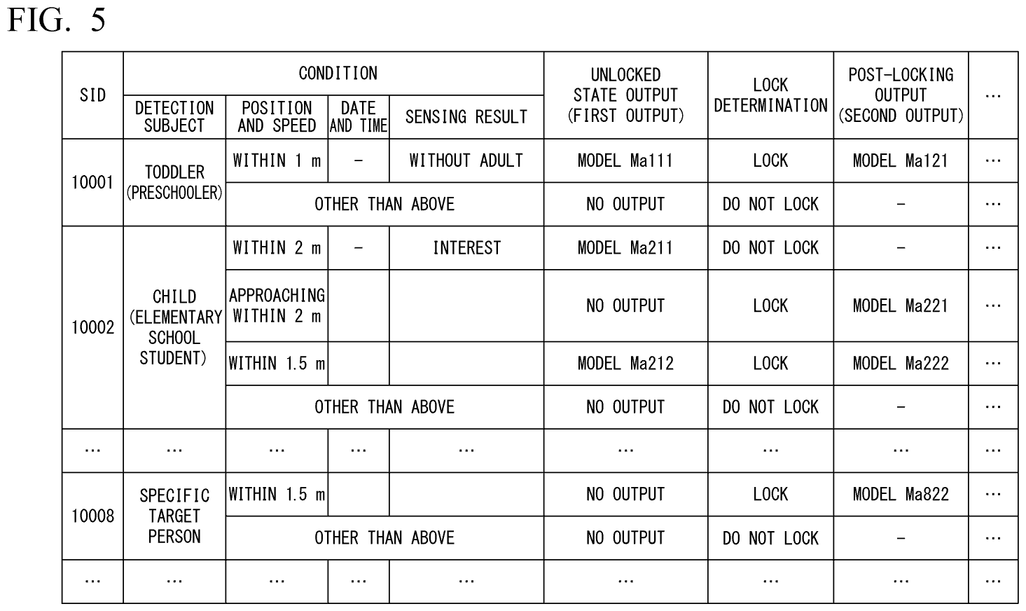

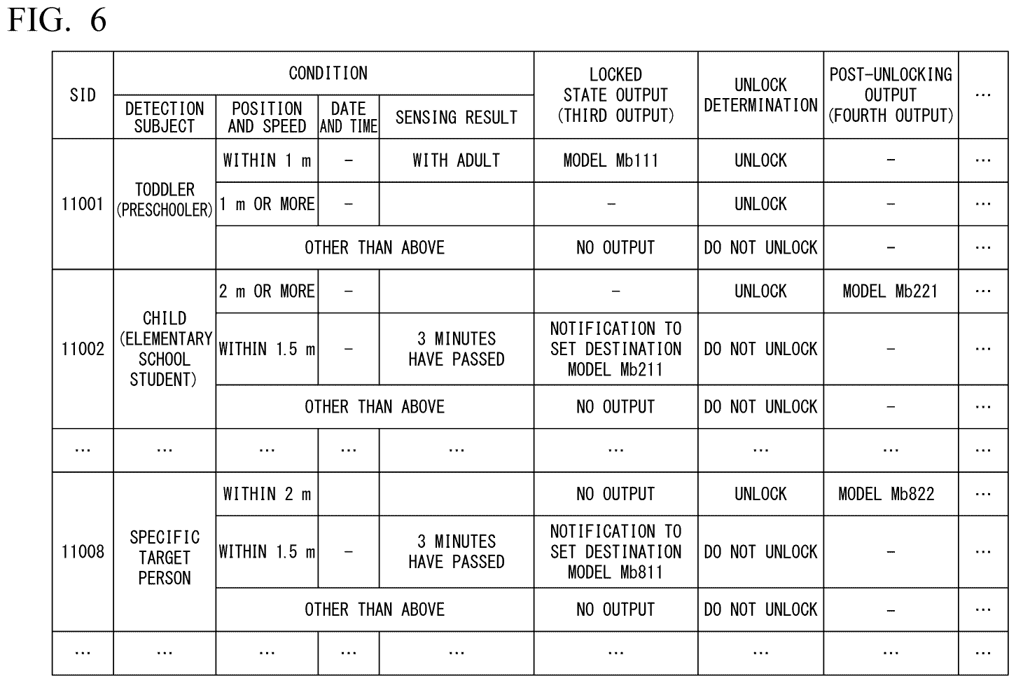

The scenario storage unit 122 stores scenario information to determine the notification content to be output by the electronic lock 1 and for determining lock control. Here, examples of data in the scenario storage unit 122 will be described with reference to FIGS. 5 and 6.

FIGS. 5 and 6 are diagrams showing examples of data in the scenario storage unit 122 according to the present embodiment. FIG. 5 shows the notification content and the lock control scenario in a case where the lock unit 14 is in an unlocked state. FIG. 6 shows the notification content and the lock control scenario in a case where the lock unit 14 is in a locked state.

As shown in FIG. 5, the scenario storage unit 122 stores, in association with each other, a scenario ID (SID), a condition, an unlocked state output (first output), a lock determination, and a post-locking output (second output) as scenario information in a case where the lock unit 14 is in an unlocked state.

Here, the SID is identification information for identifying a scenario, and the conditions include the detection subject, the position and speed, the date and time, and the sensing result. The detection subject indicates the opening/closing person who is the target to be recognized. Furthermore, the detection subjects include, for example, specific target persons such as alcoholics, dementia patients, visually impaired, and hearing impaired, in addition to toddlers (preschoolers) and children (elementary school students). In the sensing results shown in FIG. 5, for example, “interest” indicates that an action of showing interest, such as approaching an opening/closing target, has been detected.

In addition, the unlocked state output (first output) indicates trained model information to determine the notification content in a case where the electronic lock 1 is in the unlocked state. In addition, in the unlocked state output (first output), in a case where the notification content is not to be output, information indicating “no output” is set.

The lock determination indicates the result of determination as to whether or not the lock unit 14 is to be locked.

In addition, the post-locking output (second output) indicates trained model information to determine the notification content after the electronic lock 1 is locked.

For example, in the example shown in FIG. 5, in a case where the electronic lock 1 is in an unlocked state, the scenario information for SID “1001” indicates that, in a case where a toddler (preschooler) approaches within 1 meter (m) of the opening/closing target without an adult, the notification content determined using “model Ma111” is output and the lock unit 14 is locked, and further, after the locking, the notification content determined using “model Ma121” is output.

Also, as shown in FIG. 6, the scenario storage unit 122 stores, in association with each other, a scenario ID (SID), a condition, a locked state output (third output), an unlock determination, and a post-unlocking output (fourth output) as scenario information in a case where the lock unit 14 is in a locked state.

Here, the SID and conditions are the same as those in FIG. 5.

In addition, the locked state output (third output) indicates trained model information to determine the notification content in a case where the electronic lock 1 is in the locked state. In addition, in the locked state output (third output), in a case where the notification content is not to be output, information indicating “no output” is set.

The unlock determination indicates the result of determination as to whether or not the lock unit 14 is to be unlocked.

In addition, the post-unlocking output (fourth output) indicates trained model information to determine the notification content after the electronic lock 1 is unlocked.

For example, in the example shown in FIG. 6, in a case where the electronic lock 1 is in a locked state, the scenario information for SID “1001” indicates that, in a case where a toddler (preschooler) approaches within 1 m of the opening/closing target with an adult, the notification content determined using “model Ma111” is output and the lock unit 14 is unlocked, and further, after the unlocking, no notification content is output.

Referring back to FIG. 4, the model storage unit 123 stores trained model information (face recognition model, and the like) for recognizing an opening/closing person from, for example, the image captured by the imaging unit 112, other sensing information, and the like. In addition, the model storage unit 123 stores trained model information (notification determination model) to determine the above-mentioned notification content. The model storage unit 123 stores, for example, a model ID (an example of model identification information) and each piece of trained model information in association with each other.

In addition, the model storage unit 123 stores a trained model (notification determination model) that is trained for each locking status of the opening/closing target and that determines the notification content for each locking status of the opening/closing target. Here, the locking status of the opening/closing target includes, for example, an unlocked state of the lock unit 14, a state after the lock unit 14 is changed from an unlocked state to a locked state (post-locking state), a locked state of the lock unit 14, and a state after the lock unit 14 is changed from a locked state to an unlocked state (post-unlocking state). The model storage unit 123 stores trained models (notification determination models) corresponding to each of these four situations.

The collected information storage unit 124 stores image data captured by the imaging unit 112 and various types of sensing information acquired from other devices via the communication unit 111.

The log storage unit 125 stores historical information on the opening/closing person (target to be locked) recognized by the electronic lock 1, the notifications output, and the lock determination (lock control) in association with date and time information.

The setting update unit 131, the information collection unit 132, the recognition unit 133, the determination unit 134, the output control unit 135, and the lock control unit 136 are functional units realized by causing the processor P1 to execute programs stored in a built-in memory (not shown) or in the memory M1.

The setting update unit 131 updates the lock setting information, scenario information, and model information based on information acquired from the outside via the communication unit 111. Based on the acquired information, the setting update unit 131 executes update processes such as adding, changing, and deleting the setting information of the electronic lock 1 stored in the lock setting storage unit 121. In addition, the setting update unit 131 executes update processes such as adding, changing, and deleting the scenario information stored in the scenario storage unit 122 based on the acquired information. Furthermore, the setting update unit 131 executes update processes such as adding, changing, and deleting the model information stored in the model storage unit 123 based on the acquired information.

The information collection unit 132 collects image data captured by the imaging unit 112 and various types of sensing information acquired from other devices via the communication unit 111. The information collection unit 132 stores the collected image data and various sensing information in the collected information storage unit 124. The information collected by the information collection unit 132 is used to recognize the opening/closing person. In addition, the information collected by the information collection unit 132 may include, for example, images acquired by external home appliances such as air conditioners, information acquired by human presence sensors, and information detected about the content or states of the refrigerator O1.

The recognition unit 133 recognizes an opening/closing person who performs an opening/closing action on an opening/closing target. The recognition unit 133 recognizes the opening/closing person from the collected information stored by the information collection unit 132, for example, by using trained model information (such as a face recognition model) for recognizing the opening/closing person stored in the model storage unit 123. The recognition unit 133 may recognize attribute information of the opening/closing person, such as the age, height, and the like, of the opening/closing person, in addition to specifying the opening/closing person.

The recognition unit 133 may also recognize the opening/closing person by combining image data captured by the imaging unit 112 with various types of sensing information acquired from other home appliances.

The determination unit 134 performs a notification determination (for example, a speech determination) to determine the notification content and a lock determination to determine unlock control or lock control for the opening/closing target according to the opening/closing person recognized by the recognition unit 133. The determination unit 134 performs a notification determination and a lock determination based on the setting information of the electronic lock 1 stored in the lock setting storage unit 121.

For example, the determination unit 134 acquires scenario information set as setting information for the electronic lock 1 from the scenario storage unit 122, and in a case where the conditions contained in the scenario information are satisfied, determines the notification content using the trained model stored in the model storage unit 123. In addition, the determination unit 134 determines lock control based on the scenario information.

The determination unit 134 is capable of performing notification determinations and lock determinations according to various situations by changing the set scenario information according to the setting information of the electronic lock 1.

For example, the determination unit 134 changes the scenario information according to the setting information of the electronic lock 1, and performs a notification determination and a lock determination according to the personality set in association with the opening/closing person. Here, the set personality may be, for example, calm, strong-willed, or liking/disliking of the opening/closing person. The determination unit 134 determines the notification content based on the set personality by using the trained model included in the set scenario information.

Furthermore, as shown in FIG. 5, in a case where the opening/closing target is in an unlocked state, the determination unit 134 may determine whether or not to perform lock control as a lock determination. Furthermore, as shown in FIG. 6, in a case where the opening/closing target is in a locked state, the determination unit 134 may determine whether or not to perform unlock control as a lock determination depending on whether or not an unlocking condition is satisfied. The unlocking conditions include, for example, the passage of a specific time, the presence of another accompanying person, such as an adult, near the opening/closing person, such as the presence of another accompanying person at home, and the like. In addition, whether or not an accompanying person is nearby may be determined, for example, in conjunction with the operation history or scheduling function of the accompanying person's smartphone.

In addition, the determination unit 134 may perform a notification determination for each locking status of the opening/closing target based on the trained model stored in the model storage unit 123.

In addition, the determination unit 134 sets scenario information for each opening/closing person (detection subject) using the setting information of the electronic lock 1 and determines the notification content to deter or warn about the opening/closing action according to the recognized opening/closing person. For example, in a case where the opening/closing person is a toddler, a child, or an alcoholic, the notification content is determined to deter or warn about the opening/closing action depending on the individual opening/closing person.

In addition, the determination unit 134 may set scenario information for each opening/closing person (detection subject) using the setting information of the electronic lock 1 and determine whether or not to perform a notification determination or a lock determination according to the recognized opening/closing person. For example, the determination unit 134 may perform a notification determination or a lock determination in a case where the opening/closing person is a child, but may not perform a notification determination or a lock determination in a case where the opening/closing person is an adult.

In addition, the determination unit 134 may determine the notification content according to the opening/closing target or the contents held in the opening/closing target by changing the setting information of the electronic lock 1. The determination unit 134 changes the notification content depending on whether the opening/closing target is the refrigerator O1 or a balcony window, for example. Furthermore, the determination unit 134 may change the notification content for the child depending on whether or not ice cream is stored in the refrigerator O1 (opening/closing target), for example.

In addition, the determination unit 134 may determine the notification content according to the status of the opening/closing action for the opening/closing target by changing the setting information of the electronic lock 1. For example, in a case where the acceleration or speed of opening/closing is high, the determination unit 134 may be configured to cause the refrigerator O1 to provide a notification saying “ouch” to prevent rough handling or to provide a warning notification to be careful about how the refrigerator is opened and closed. In addition, the determination unit 134 may, for example, provide a warning notification to a child who leaves the refrigerator O1 open, to close the refrigerator O1.

In addition, the determination unit 134 may change the scenario information according to the setting information of the electronic lock 1 and further perform determinations such as (a1) to (a4) as follows.
(a1) The determination unit 134 performs a first notification determination, and in a case where the recognition unit 133 re-recognizes the opening/closing person after the output control unit 135 to be described later outputs a notification based on first notification content, the determination unit 134 performs a second notification determination that is different from the first notification determination. This example is a case where the electronic lock 1 outputs a different notification (second notification content) depending on the first notification content, for example, after notifying the opening/closing person of a warning and depending on the action or the like of the opening/closing person after being warned.
(a2) The determination unit 134 performs a first lock determination, and in a case where the recognition unit 133 re-recognizes the opening/closing person after the lock control unit 136 to be described later performs lock control based on the first lock determination, the determination unit 134 performs a second lock determination. This example is a case where the electronic lock 1 initially leaves the door unlocked, issues a warning, and then performs control to lock the door after the warning has been issued.
(a3) The determination unit 134 performs a second lock determination and a second notification determination based on the re-recognized opening/closing person and the result of the first notification determination. This example is a case where the determination unit 134, for example, after issuing a warning once, performs a lock determination and a notification determination depending on the content of the warning and the action of the opening/closing person after the warning.
(a4) The determination unit 134 performs a lock determination according to the position where the recognized opening/closing person touched the opening/closing target, the approach speed of the opening/closing person, or the date and time information when the opening/closing person is recognized. This example is a case where the determination unit 134 issues a warning once, but in a case where the person approaches, the determination unit 134 performs further lock determination and notification determination. In addition, this example includes a case where, in a case where the re-recognized opening/closing person touches the opening/closing target (for example, the refrigerator O1), the determination unit 134 performs a second lock determination to lock the door and also performs a second notification determination to notify the opening/closing person of the reason for locking and includes a case where the lock determination and notification determination are changed depending on the time period or day of the week, and the like.

The output control unit 135 performs output control to output a notification to the opening/closing person based on notification content obtained through the notification determination by the determination unit 134. That is, the output control unit 135 performs output control to output the notification content to the opening/closing person according to the opening/closing person recognized by the recognition unit 133. As output control, the output control unit 135 causes the output unit 113, which is a speaker, to output a voice based on the notification content, for example. Note that the output control unit 135 may be configured to cause a display unit to output display content (for example, a message) based on the notification content, assuming that the output unit 113 includes the display unit.

The lock control unit 136 performs lock control to control unlocking or locking depending on the lock determination. That is, the lock control unit 136 performs lock control to control unlocking or locking of the opening/closing target, according to the opening/closing person recognized by the recognition unit 133. The lock control unit 136 controls the drive unit 145 of the lock unit 14 to fix the plate 141 with the lock bolt 144 and make it unrotatable, thereby setting the electronic lock 1 in a locked state. In addition, the lock control unit 136 controls the drive unit 145 of the lock unit 14 to release the fixing of the plate 141 by the lock bolt 144 and make the plate 141 rotatable, thereby setting the electronic lock 1 in an unlocked state.

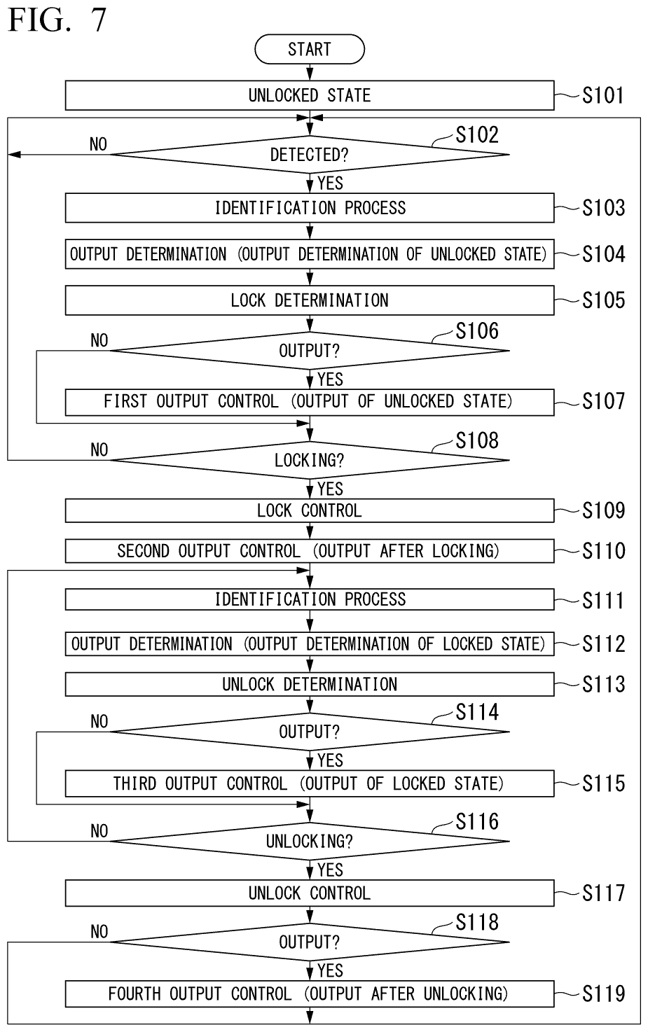

Next, the operation of the electronic lock 1 according to the present embodiment will be described with reference to FIG. 7.

FIG. 7 is a flowchart showing an example of an operation of the electronic lock 1 according to the present embodiment.

As shown in FIG. 7, the electronic lock 1 is first set to an unlocked state (step S101). The lock control unit 136 of the electronic lock 1 controls the lock unit 14 to set the electronic lock 1 to an unlocked state as an initial state.

Next, the recognition unit 133 of the electronic lock 1 determines whether or not a person (opening/closing person) has been detected (step S102). The recognition unit 133 determines whether or not a person (opening/closing person) has been detected based on the information collected by the information collection unit 132 (for example, image data captured by the imaging unit 112, and the like). In a case where a person (opening/closing person) has been detected (step S102: YES), the recognition unit 133 advances the process to step S103. Moreover, in a case where a person (opening/closing person) has not been detected (step S102: NO), the recognition unit 133 returns the process to step S102.

In step S103, the recognition unit 133 executes an identification process. The recognition unit 133 executes a process of specifying and recognizing the detected opening/closing person, for example, by using a face recognition model stored in the model storage unit. In a case where a plurality of people have been detected, the recognition unit 133 specifies and recognizes the opening/closing person and the accompanying person, respectively.

Next, the determination unit 134 of the electronic lock 1 performs an output determination (output determination of the unlocked state) (step S104). The determination unit 134 refers from the scenario storage unit 122 to the scenario information set in the lock setting storage unit 121 in accordance with the opening/closing person recognized by the recognition unit 133 and performs a notification determination to determine the notification content as an output determination (output determination of the unlocked state) based on the set scenario information.

Next, the determination unit 134 performs a lock determination (step S105). The determination unit 134 performs a lock determination as to whether or not to perform lock control based on the set scenario information.

Next, the output control unit 135 of the electronic lock 1 determines whether or not to output (step S106). The output control unit 135 determines whether or not to output a notification (for example, a voice) based on the result of the notification determination. In a case where it is determined that a notification (for example, a voice) is to be output (step S106: YES), the output control unit 135 advances the process to step S107. Furthermore, in a case where it is determined that a notification (for example, a voice) is not to be output (step S106: NO), the output control unit 135 advances the process to step S108.

In step S107, the output control unit 135 performs first output control (output of the unlocked state). The output control unit 135 causes the output unit 113 to output a voice in the unlocked state based on the notification content of the notification determination. After the process of step S107, the output control unit 135 advances the process to step S108.

In addition, in step S107, the output of the unlocked state output by the output control unit 135 is, for example, the output of the notification determined by the determination unit 134 based on the notification determination model set to the unlocked state output (first output) in the scenario information shown in FIG. 5.

In step S108, the lock control unit 136 determines whether or not to lock the door. The lock control unit 136 determines whether or not to lock the electronic lock 1 based on the result of the lock determination. In a case where it is determined that the electronic lock 1 is to be locked (step S108: YES), the lock control unit 136 advances the process to step S109. Furthermore, in a case where it is determined that the electronic lock 1 is not to be locked (step S108: NO), the lock control unit 136 returns the process to step S102.

In step S109, the lock control unit 136 performs lock control. The lock control unit 136 controls the lock unit 14 to change the state of the electronic lock 1 from an unlocked state to a locked state.

Next, the output control unit 135 performs second output control (output after locking) (step S110). The output control unit 135 causes the output unit 113 to output a voice after locking based on the notification content of the notification determination. Before the process of step S110, the output control unit 135 may perform an output determination process to determine whether or not to output, similarly to the above-described step S106.

In addition, in step S110, the output after locking, which is output by the output control unit 135, is, for example, the output of the notification determined by the determination unit 134 based on the notification determination model set to the post-locking output (second output) in the scenario information shown in FIG. 5.

Next, the recognition unit 133 executes an identification process (step S111). The recognition unit 133 executes a re-recognition process of specifying and recognizing the detected opening/closing person, for example, by using a face recognition model stored in the model storage unit.

Next, the determination unit 134 performs an output determination (output determination of the locked state) (step S112). The determination unit 134 refers from the scenario storage unit 122 to the scenario information set in the lock setting storage unit 121 in accordance with the opening/closing person re-recognized by the recognition unit 133 and performs a notification determination to determine the notification content as an output determination (output determination of the locked state) based on the set scenario information.

Next, the determination unit 134 performs a lock determination (step S113). The determination unit 134 performs a lock determination as to whether or not to perform unlock control based on the set scenario information.

Next, the output control unit 135 determines whether or not to output (step S114). The output control unit 135 determines whether or not to output a notification (for example, a voice) based on the result of the notification determination. In a case where it is determined that a notification (for example, a voice) is to be output (step S114: YES), the output control unit 135 advances the process to step S115. Furthermore, in a case where it is determined that a notification (for example, a voice) is not to be output (step S114: NO), the output control unit 135 advances the process to step S116.

In step S115, the output control unit 135 performs third output control (output of the locked state). The output control unit 135 causes the output unit 113 to output a voice in the locked state based on the notification content of the notification determination. After the process of step S115, the output control unit 135 advances the process to step S116.

In addition, in step S115, the output of the locked state output by the output control unit 135 is, for example, the output of the notification determined by the determination unit 134 based on the notification determination model set to the locked state output (third output) in the scenario information shown in FIG. 6.

In step S116, the lock control unit 136 determines whether or not to unlock the door. The lock control unit 136 determines whether or not to unlock the electronic lock 1 based on the result of the lock determination. In a case where it is determined that the electronic lock 1 is to be unlocked (step S116: YES), the lock control unit 136 advances the process to step S117. Furthermore, in a case where it is determined that the electronic lock 1 is not to be unlocked (step S116: NO), the lock control unit 136 returns the process to step S111.

In step S117, the lock control unit 136 performs unlock control. The lock control unit 136 controls the lock unit 14 to change the state of the electronic lock 1 from a locked state to an unlocked state.

Next, the output control unit 135 determines whether or not to output (step S118). The output control unit 135 determines whether or not to output a notification (for example, a voice) after unlocking based on the result of the notification determination. In a case where it is determined that a notification (for example, a voice) after unlocking is to be output (step S118: YES), the output control unit 135 advances the process to step S119. Furthermore, in a case where it is determined that a notification (for example, a voice) after unlocking is not to be output (step S118: NO), the output control unit 135 returns the process to step S102.

In step S119, the output control unit 135 performs fourth output control (output after unlocking). The output control unit 135 causes the output unit 113 to output a voice after unlocking based on the notification content of the notification determination. After the process of step S119, the output control unit 135 returns the process to step S102.

In addition, in step S119, the output after unlocking, which is output by the output control unit 135, is, for example, the output of the notification determined by the determination unit 134 based on the notification determination model set to the post-unlocking output (fourth output) in the scenario information shown in FIG. 6.

In addition, in FIG. 7 described above, before the process of step S110, the electronic lock 1 may perform the identification process and the output determination process again. In addition, before the process of step S117, the electronic lock 1 may perform the identification process and the output determination process again.

Next, additional services of the opening/closing control system 100 according to the present embodiment will be described with reference to the drawings.

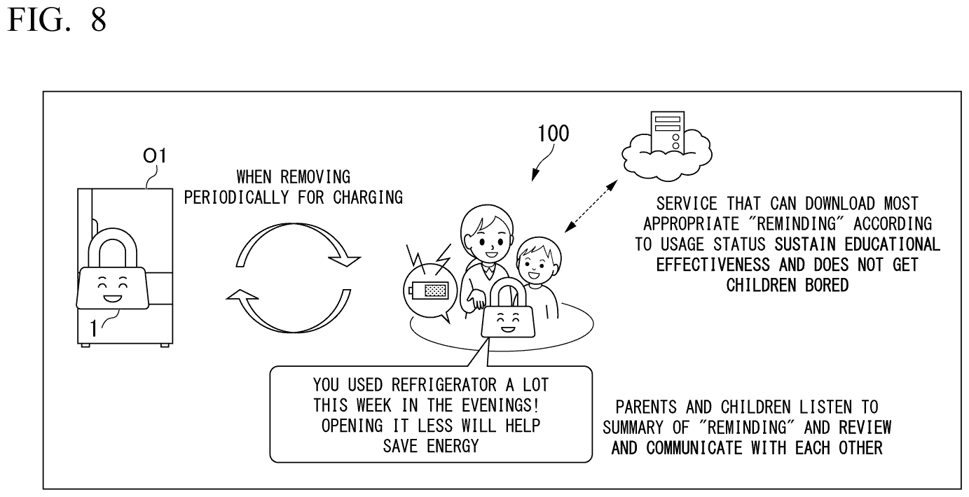

FIG. 8 is an image diagram showing an overview of additional services of the opening/closing control system 100 according to the present embodiment.

As shown in FIG. 8, in the opening/closing control system 100 according to the present embodiment, the electronic lock 1 can be periodically removed from the opening/closing target (refrigerator O1) to charge the battery of the power supply 15.

In addition, the electronic lock 1 makes it possible to check the history of the opening/closing action of the opening/closing person, for example, using a mobile terminal 2 to be described later and can download the most appropriate “reminding” (notification content) according to a usage status.

Next, a configuration example of the opening/closing control system 100 according to the present embodiment including additional services will be described with reference to FIG. 9.

FIG. 9 is a configuration diagram showing an example of the opening/closing control system 100 according to the present embodiment.

As shown in FIG. 9, the opening/closing control system 100 includes an electronic lock 1, a mobile terminal 2, an application server 3, an SNS server 4, a distribution server 5, and a management server 6.

The application server 3, the SNS server 4, the distribution server 5, and the management server 6 are connected to a network NW. In addition, the mobile terminal 2 is connectable to the network NW via a base station BS.

The mobile terminal 2 is, for example, a mobile terminal device such as a smartphone or a tablet terminal. The mobile terminal 2 communicates with the communication unit 111 of the electronic lock 1 by executing a management application (application program) for the electronic lock 1. The mobile terminal 2 performs lock settings for the electronic lock 1 and acquires log information on opening/closing control from the electronic lock 1. The mobile terminal 2 can display and check the log information acquired from the electronic lock 1.

In addition, the mobile terminal 2 connects to the application server 3, the SNS server 4, the distribution server 5, and the management server 6 via the network NW by executing a dedicated application for the electronic lock 1. The mobile terminal 2 transmits log information on the opening/closing control to the application server 3 and also acquires reports and articles of incorporation from the application server 3.

In addition, the mobile terminal 2 acquires various types of model information, scenario information, setting information, voice data, and the like from the distribution server 5. The mobile terminal 2 transmits the information acquired from the distribution server 5 to the electronic lock 1 and uses the information to set the electronic lock 1.

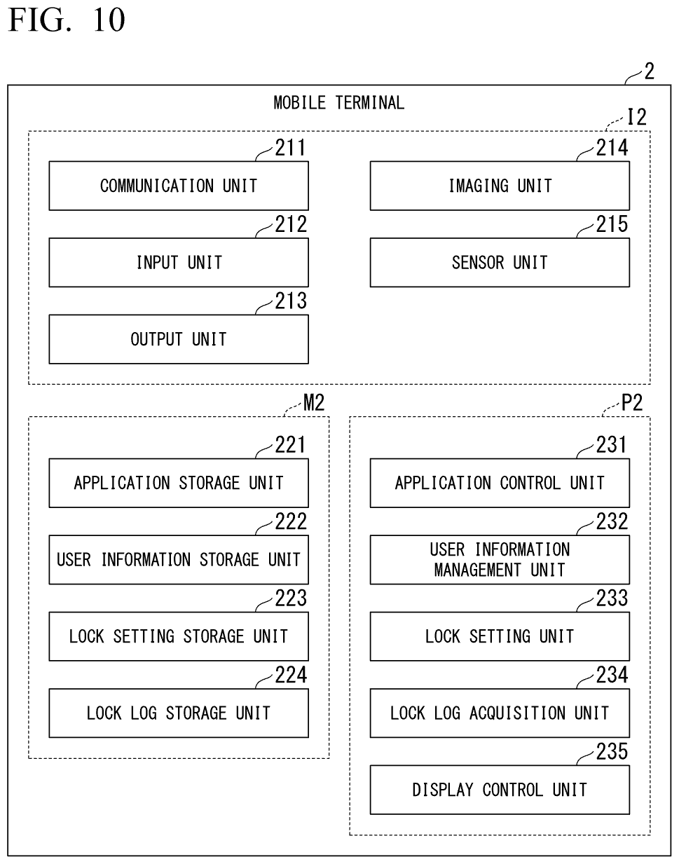

Here, the configuration of the mobile terminal 2 will be described with reference to FIG. 10.

FIG. 10 is a block diagram showing an example of the mobile terminal 2 according to the present embodiment.

As shown in FIG. 10, the mobile terminal 2 includes a communication unit 211, an input unit 212, an output unit 213, an imaging unit 214, a sensor unit 215, an application storage unit 221, a user information storage unit 222, a lock setting storage unit 223, a lock log storage unit 224, an application control unit 231, a user information management unit 232, a lock setting unit 233, a lock log acquisition unit 234, and a display control unit 235.

The communication unit 211, the input unit 212, the output unit 213, the imaging unit 214, and the sensor unit 215 are included in an input/output module 12.

The communication unit 211 is a communication module for mobile communication, wireless LAN, Bluetooth (registered trademark), and the like. The communication unit 211 communicates with the electronic lock 1 and connects to the network NW via the base station BS, for example, by mobile communication. The communication unit 211 communicates with the application server 3, the SNS server 4, the distribution server 5, and the management server 6 via the network NW.

The input unit 212 is an input device such as a keyboard, a touch screen, and a button. The input unit 212 receives various types of input information in response to operations by a user. The input unit 212 is used when setting the electronic lock 1.

The output unit 213 is, for example, a display unit such as a liquid crystal display, a speaker, or the like. The output unit 213 is used to output the setting screen of the electronic lock 1, log information, or the like.

The imaging unit 214 is a camera having a CCD image sensor or the like. The imaging unit 214 is capable of acquiring various types of image information.

The sensor unit 215 is, for example, an acceleration sensor, and detects various types of sensor information.

In addition, the application storage unit 221, the user information storage unit 222, the lock setting storage unit 223, and the lock log storage unit 224 are storage units realized by a memory M2.

The memory M2 is, for example, a storage device such as a RAM, a flash memory, or an HDD and stores various types of information and programs used by the mobile terminal 2.

The application storage unit 221 stores the program and usage information of the management application for the electronic lock 1.

The user information storage unit 222 stores, for example, user information, which is information regarding a user who uses the electronic lock 1. Here, an example of data in the user information storage unit 222 will be described with reference to FIG. 11.

FIG. 11 is a diagram showing an example of data in the user information storage unit 222 according to the present embodiment.

As shown in FIG. 11, the user information storage unit 222 stores, for example, a user ID, user information, and a lock ID in association with each other. Here, the user ID is user identification information for identifying the user of the lock ID. The user information also includes, for example, basic information (for example, name, address, email, and the like), SNS information, and billing information.

The SNS information is, for example, SNS related information such as an SNS group to which the user belongs and follower information. In addition, the billing information is, for example, billing information such as the usage fee for the management application, additional scenarios, model information, and additional services.

Referring back to FIG. 10, the lock setting storage unit 223 stores information regarding the lock settings set in the electronic lock 1 using the management application. The lock setting storage unit 223 stores, for example, information as shown in FIGS. 12 to 14.

FIG. 12 is a diagram showing an example of data of target person setting information in the lock setting storage unit 223 according to the present embodiment.

As shown in FIG. 12, the lock setting storage unit 223 stores, for example, a lock ID, a target person ID, a care target person, a care type, and a care policy in association with each other as target person setting information. Here, the target person ID is, for example, identification information for identifying the opening/closing person, and the care target person is a parent, caregiver, or the like who manages (takes care of) the opening/closing person. The care type includes, for example, child care, elderly care, and alcoholism support. Also, the care policy is, for example, strict, gentle, and the like.

FIG. 13 is a diagram showing an example of data of lock setting information in the lock setting storage unit 223 according to the present embodiment.

As shown in FIG. 13, the lock setting storage unit 223 stores, for example, a lock ID, a target to be locked, a target person ID, and a scenario ID in association with each other as lock setting information. Here, the target to be locked is information indicating the opening/closing target on which the electronic lock 1 is installed, for example, a refrigerator, a balcony window, or the like.

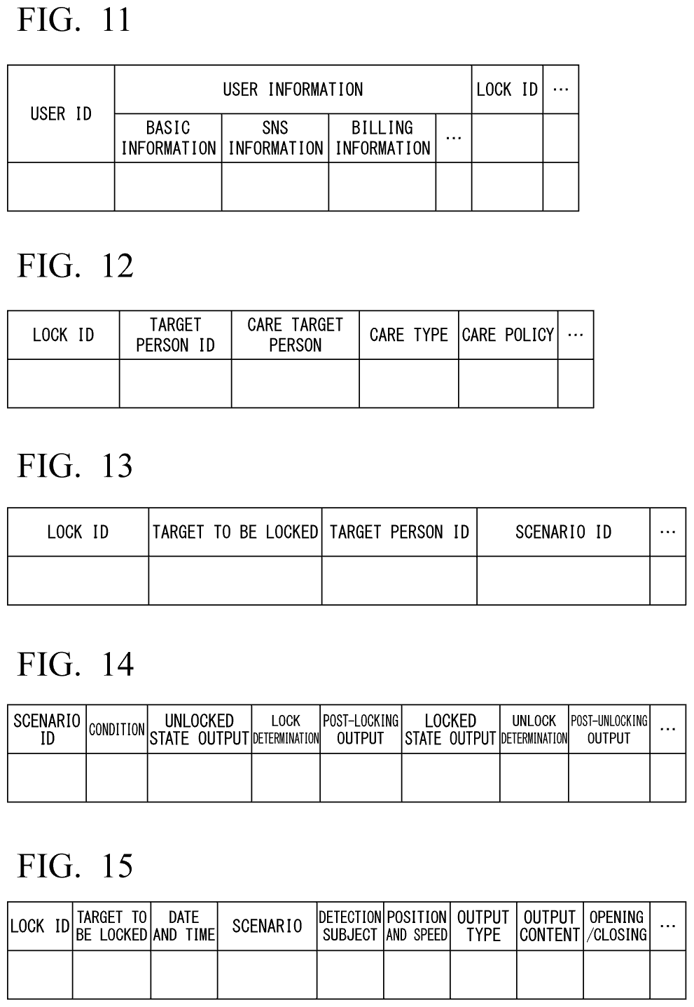

FIG. 14 is a diagram showing an example of data of scenario setting information in the lock setting storage unit 223 according to the present embodiment.

As shown in FIG. 14, the lock setting storage unit 223 stores, for example, a scenario ID, a condition, an unlocked state output, a lock determination, a post-locking output, a locked state output, an unlock determination, and a post-unlocking output, in association with each other, as scenario setting information.

Referring back to FIG. 10, the lock log storage unit 224 stores lock log information. Here, an example of data in the lock log storage unit 224 will be described with reference to FIG. 15.

FIG. 15 is a diagram showing an example of data in the lock log storage unit 224 according to the present embodiment.

As shown in FIG. 15, the lock log storage unit 224 stores log information in which, for example, a lock ID, a target to be locked, a date and time, a scenario, a detection subject, a position and speed, an output type, output content, and opening/closing, are associated with each other. Here, the output content is notification content. In addition, opening/closing indicates the lock control history of locking or unlocking the electronic lock 1.

Referring back to FIG. 10, the application control unit 231, the user information management unit 232, the lock setting unit 233, the lock log acquisition unit 234, and the display control unit 235 are functional units realized by causing a processor P2 to execute programs stored in a built-in memory (not shown) or in the memory M2.

The processor P2 is, for example, a processing circuit including a CPU. The processor P2 executes various processes of the mobile terminal 2 by executing programs stored in a built-in memory (not shown) or in the memory M2.

The application control unit 231 executes a process of the management application for the electronic lock 1. The application control unit 231 is realized by causing the processor P2 to execute a program of the management application stored in the application storage unit 221. The application control unit 231 cooperates with the application server 3, the SNS server 4, the distribution server 5, and the management server 6 to provide various services related to the electronic lock 1.

The application control unit 231 causes the lock setting unit 233 to execute a setting process in response to a setting request for the electronic lock 1 received by the input unit 212.

Furthermore, in response to a request to display log information received by the input unit 212, the application control unit 231 causes the lock log acquisition unit 234 to execute a process of acquiring log information and causes the display control unit 235 to display the log information.

In addition, the application control unit 231 executes acquisition of various types of distribution information from the distribution server 5 via the communication unit 211 in response to a download request for distribution information received by the input unit 212.

The user information management unit 232 executes a process of managing user information using the user information storage unit 222.

The lock setting unit 233 executes the setting process for the electronic lock 1. The lock setting unit 233 acquires setting information of the electronic lock 1 via the communication unit 211, displays the setting information of the electronic lock 1 using the display control unit 235, and stores the setting information of the electronic lock 1 in the lock setting storage unit 223. Further, the lock setting unit 233 changes the setting information of the electronic lock 1 based on the input information received by the input unit 212 and transmits the changed setting information of the electronic lock 1 via the communication unit 211.

The lock log acquisition unit 234 acquires log information of the electronic lock 1 via the communication unit 211, stores the acquired log information in the lock log storage unit 224, and transmits the stored log information to the management server 6 via the communication unit 211.

The display control unit 235 outputs displays of various types of information to the output unit 213 in response to requests from each unit such as the application control unit 231.

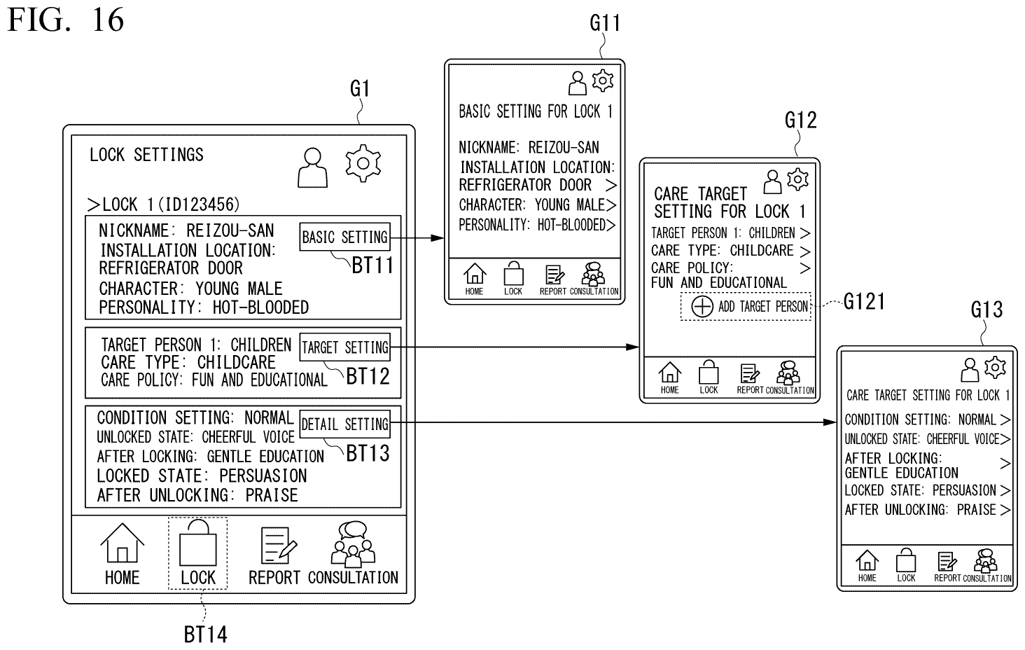

Next, with reference to FIG. 16, an example of a screen display for setting of the electronic lock 1 using the mobile terminal 2 will be described.

FIG. 16 is a diagram showing an example of a screen display for lock setting of the opening/closing control system 100 according to the present embodiment.

In FIG. 16, a display screen G1 shows a lock setting display screen that is displayed in a case where the mobile terminal 2 executes the management application and a lock button BT14 is pressed.

When the user presses a basic setting button BT11 on the display screen G1, the mobile terminal 2 displays a setting screen of the basic setting on a display screen G11. The user can set the basic setting for the electronic lock 1 on this display screen G11.

Furthermore, when the user presses a target setting button BT12 on the display screen G1, the mobile terminal 2 displays a setting screen of the target person on a display screen G12. The user can set the target person for the electronic lock 1 on this display screen G12.

Furthermore, when the user presses a detail setting button BT13 on the display screen G1, the mobile terminal 2 displays a setting screen of the detail setting on a display screen G13. The user can set the detailed setting for the electronic lock 1 on this display screen G13.

The application server 3 is a server device that provides a management application service for the electronic lock 1. The application server 3 is connectable to the mobile terminal 2 via the network NW.

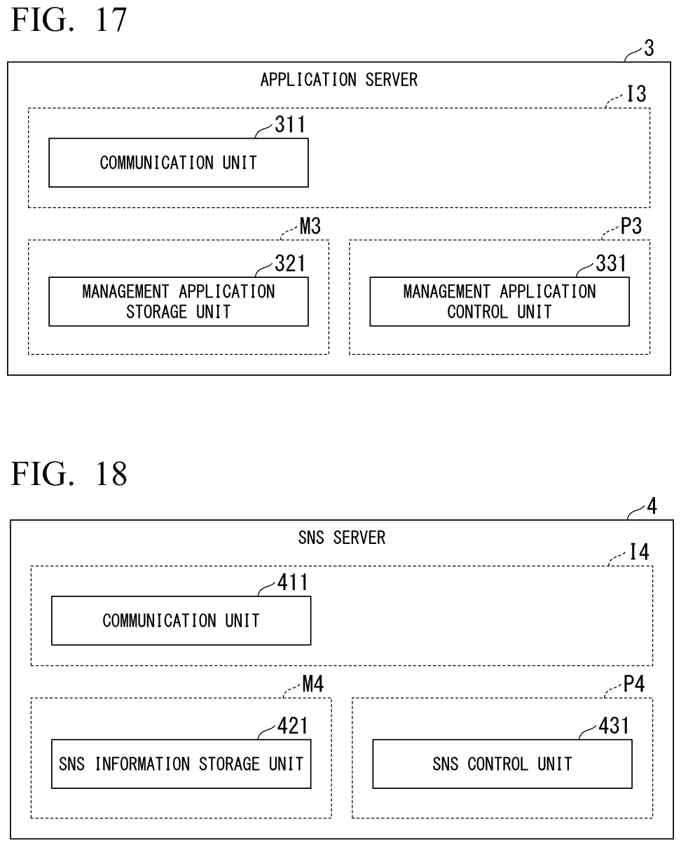

Here, the configuration of the application server 3 according to the present embodiment will be described with reference to FIG. 17.

FIG. 17 is a block diagram showing an example of the application server 3 according to the present embodiment.

As shown in FIG. 17, the application server 3 includes a communication unit 311, a management application storage unit 321, and a management application control unit 331.

The communication unit 311 is included in an input/output module 12. The communication unit 311 is, for example, a network communication module such as a LAN module. The communication unit 311 connects to the network NW and performs communication with the mobile terminal 2.

The management application storage unit 321 is a storage unit realized by a memory M3. The management application storage unit 321 stores usage information of the management application for the electronic lock 1.

The memory M3 is, for example, a storage device such as a RAM, a flash memory, or an HDD and stores various types of information and programs used by the application server 3.

The management application control unit 331 is a functional unit that is realized by causing a processor P3 to execute a program stored in a built-in memory (not shown) or the memory M3. The management application control unit 331 executes a process of various services provided by the management application of the electronic lock 1.

The processor P3 is, for example, a processing circuit including a CPU. The processor P3 executes various processes of the application server 3 by executing programs stored in a built-in memory (not shown) or in the memory M3.

The SNS server 4 is a server device that provides social networking service (SNS) information related to the electronic lock 1. The SNS server 4 is connectable to the mobile terminal 2 via the network NW.

Here, the configuration of the SNS server 4 according to the present embodiment will be described with reference to FIG. 18.

FIG. 18 is a block diagram showing an example of the SNS server 4 according to the present embodiment.

As shown in FIG. 18, the SNS server 4 includes a communication unit 411, an SNS information storage unit 421, and an SNS control unit 431.

The communication unit 411 is included in an input/output module 14. The communication unit 411 is, for example, a network communication module such as a LAN module. The communication unit 411 connects to the network NW and performs communication with the mobile terminal 2.

The SNS information storage unit 421 is a storage unit realized by a memory M4. The SNS information storage unit 421 stores SNS usage information related to the electronic lock 1.

The memory M4 is, for example, a storage device such as a RAM, a flash memory, or an HDD and stores various types of information and programs used by the SNS server 4.

The SNS control unit 431 is a functional unit that is realized by causing a processor P4 to execute a program stored in a built-in memory (not shown) or the memory M4. The SNS control unit 431 executes a process of providing SNS services related to the electronic lock 1. The SNS control unit 431 executes processes such as posting, notification, and viewing of information (for example, messages, content, and the like) for sharing information, exchanging opinions, and the like between users of the electronic lock 1. In the opening/closing control system 100 according to the present embodiment, by utilizing SNS, it is possible for users to share information on common concerns such as education, ways of dealing with them, and countermeasures (such as usage models).

The processor P4 is, for example, a processing circuit including a CPU. The processor P4 executes various processes of the SNS server 4 by executing programs stored in a built-in memory (not shown) or in the memory M4.

The distribution server 5 is a server device that distributes various types of information such as scenario information, model information, and voice data used in the electronic lock 1. The distribution server 5 is connectable to the mobile terminal 2 via the network NW.

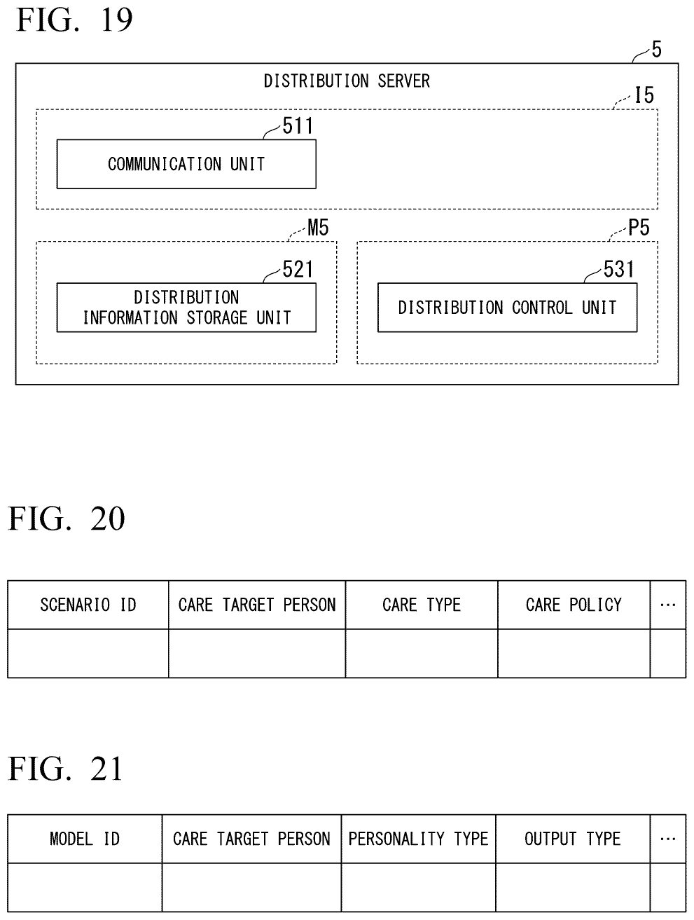

Here, the configuration of the distribution server 5 according to the present embodiment will be described with reference to FIG. 19.

FIG. 19 is a block diagram showing an example of the distribution server 5 according to the present embodiment.

As shown in FIG. 19, the distribution server 5 includes a communication unit 511, a distribution information storage unit 521, and a distribution control unit 531.

The communication unit 511 is included in an input/output module 15. The communication unit 511 is, for example, a network communication module such as a LAN module. The communication unit 511 connects to the network NW and performs communication with the mobile terminal 2.

The distribution information storage unit 521 is a storage unit realized by a memory M5. The distribution information storage unit 521 stores distribution information related to the electronic lock 1. The distribution information includes, for example, scenario information, model information, and voice data of the electronic lock 1.

Here, examples of data in the distribution information storage unit 521 will be described with reference to FIGS. 20 and 21.

FIGS. 20 and 21 are diagrams showing examples of data in the distribution information storage unit 521 according to the present embodiment.

As shown in FIG. 20, the distribution information storage unit 521 stores scenario information in which a scenario ID, a care target person, a care type, and a care policy are associated with each other.

As shown in FIG. 21, the distribution information storage unit 521 stores model information in which a model ID, a care target person, a personality type, and an output type are associated with each other.

The memory M5 is, for example, a storage device such as a RAM, a flash memory, or an HDD and stores various types of information and programs used by the distribution server 5.

The distribution control unit 531 is a functional unit that is realized by causing a processor P5 to execute a program stored in a built-in memory (not shown) or the memory M5. The distribution control unit 531 executes a process of distributing distribution information (scenario information, model information, and the like) related to the electronic lock 1.

The processor P5 is, for example, a processing circuit including a CPU. The processor P5 executes various processes of the distribution server 5 by executing programs stored in a built-in memory (not shown) or in the memory M5.

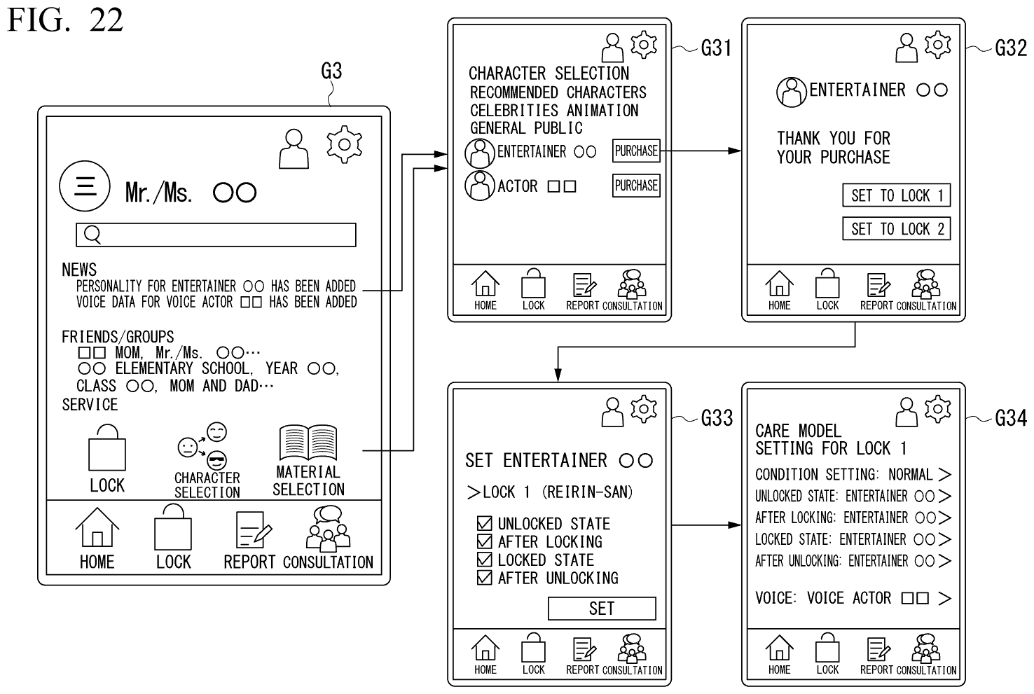

Here, an example of a display screen on the mobile terminal 2 in the process of downloading a celebrity personality model from the distribution server 5 will be described with reference to FIG. 22.

FIG. 22 is a diagram showing an example of a screen display in a distribution process of the opening/closing control system 100 according to the present embodiment. In FIG. 22, a display screen G3 shows an example of a display screen of a management application. This display screen G3 displays a notification that a personality model for entertainer OO has been added, a notification that voice data for voice actor ou has been added, and the like.

When the user designates the selection of teaching material on the display screen G3, the mobile terminal 2 displays a character selection screen (character purchase screen) on a display screen G31.

Next, when the user selects to purchase “Entertainer OO” on the display screen G31, the mobile terminal 2 displays a purchase completion screen on a display screen G32.

Next, when the user selects the settings of the electronic lock 1 on the display screen G32, the mobile terminal 2 displays a setting screen for entertainer OO on a display screen G33.

Next, when the user completes the settings of the electronic lock 1 on the display screen G33, the mobile terminal 2 displays a checking screen for the setting information of the electronic lock 1 on a display screen G34. In this way, in the opening/closing control system 100 according to the present embodiment, various types of distribution information can be purchased from the distribution server 5.

The management server 6 is a server device that manages the electronic lock 1 and executes a model learning process. The management server 6 is connectable to the mobile terminal 2, the application server 3, the SNS server 4, and the distribution server 5 via the network NW.

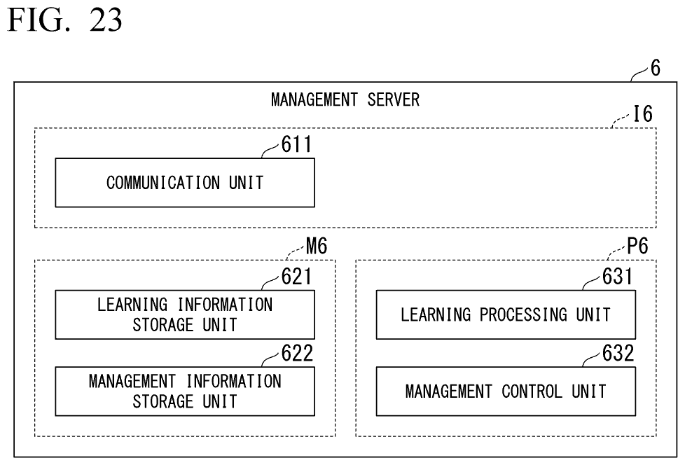

Here, the configuration of the management server 6 according to the present embodiment will be described with reference to FIG. 23.

FIG. 23 is a block diagram showing an example of the management server 6 according to the present embodiment.

As shown in FIG. 23, the management server 6 includes a communication unit 611, a learning information storage unit 621, a management information storage unit 622, a learning processing unit 631, and a management control unit 632.

The communication unit 611 is included in an input/output module 16. The communication unit 611 is, for example, a network communication module such as a LAN module. The communication unit 611 is connected to the network NW and performs communication between the mobile terminal 2, the application server 3, the SNS server 4, and the distribution server 5.

The learning information storage unit 621 and the management information storage unit 622 are storage units realized by a memory M6.

The memory M6 is, for example, a storage device such as a RAM, a flash memory, or an HDD and stores various types of information and programs used by the management server 6.

The learning information storage unit 621 stores learning information for generating a trained model through machine learning. The learning information includes, for example, learning data for generating a trained model to determine the notification content.

The management information storage unit 622 stores management information of the electronic lock 1. The management information includes user information, lock information such as a lock ID, lock setting information, and billing information.

The learning processing unit 631 and the management control unit 632 are functional units that are realized by causing a processor P6 to execute a program stored in a built-in memory (not shown) or the memory M6.

The processor P6 is, for example, a processing circuit including a CPU. The processor P6 executes various processes of the management server 6 by executing programs stored in a built-in memory (not shown) or in the memory M6.

The learning processing unit 631 executes a learning process of generating a trained model through machine learning. The learning processing unit 631 extracts learning data from log information and the like stored in the management information storage unit 622, stores the learning data in the learning information storage unit 621, and generates a trained model from the learning data through machine learning. The learning processing unit 631 uses machine learning to generate, for example, a trained model that determines the notification content for each locking status of the opening/closing target. The locking status of the opening/closing target includes, for example, a state in which the lock unit 14 is unlocked, a state immediately after the lock unit 14 is changed from an unlocked state to a locked state (post-locking state), a state in which the lock unit 14 is locked, and a state immediately after the lock unit 14 is changed from a locked state to an unlocked state (post-unlocking state).

In addition, the learning processing unit 631 transmits the generated trained model to the distribution server 5 via the communication unit 611 and stores the transmitted trained model in the distribution information storage unit 521 of the distribution server 5.

The management control unit 632 executes various management processes related to the electronic lock 1.

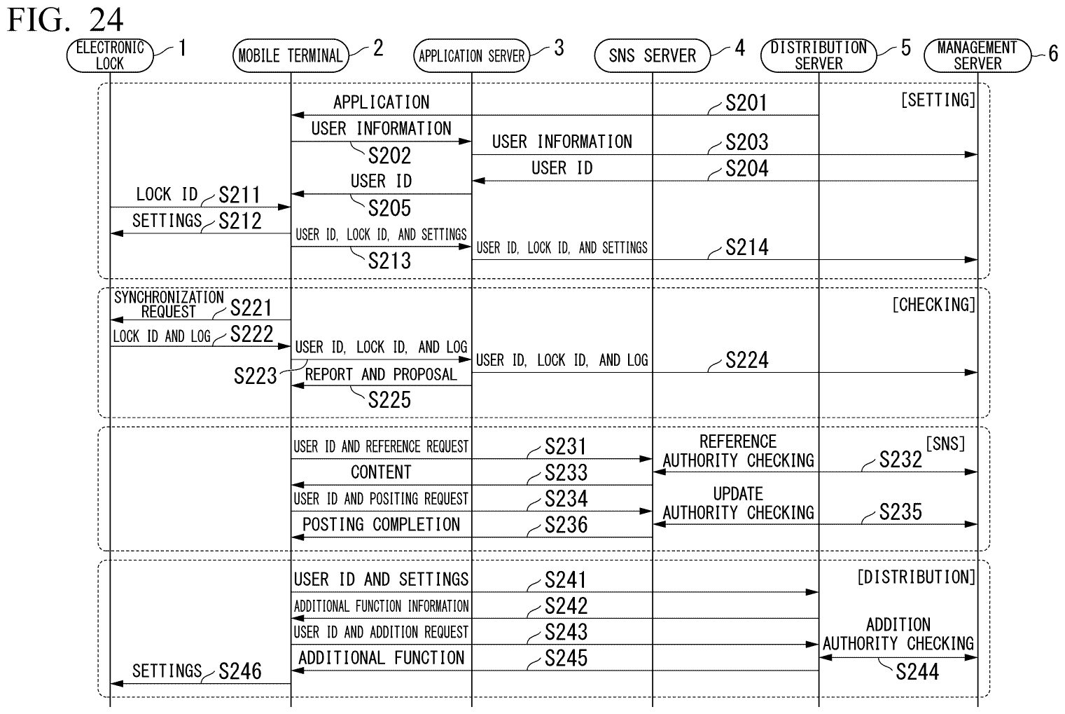

Next, the operation of the opening/closing control system 100 including additional services will be described with reference to FIG. 24.

FIG. 24 is a diagram showing an example of an operation of the opening/closing control system 100 according to the present embodiment.

As shown in FIG. 24, in the setting process of the electronic lock 1, first, the mobile terminal 2 downloads an application (management application) from the distribution server 5 (step S201). The mobile terminal 2 stores the downloaded application in the application storage unit 221.

Next, the mobile terminal 2 transmits user information to the application server 3 (step S202). The application control unit 231 of the mobile terminal 2 transmits user information to the application server 3 and performs user registration. The application server 3 stores the user information in the management application storage unit 321.

Next, the application server 3 transmits the user information to the management server 6 (step S203). The management server 6 registers the user information and generates a user ID.

Next, the management server 6 transmits the user ID to the application server 3 (step S204). The application server 3 associates the received user ID and the user information with each other and stores them in the management application storage unit 321.

Next, the application server 3 transmits the user ID to the mobile terminal 2 (step S205). The mobile terminal 2 associates the received user ID and the user information with each other and stores them in the user information storage unit 222.

Next, the mobile terminal 2 acquires a lock ID from the electronic lock 1 (step S211). The electronic lock 1 transmits the lock ID to the mobile terminal 2, for example, in response to a request from the mobile terminal 2.

Next, the mobile terminal 2 transmits information to the electronic lock 1 (step S212). The mobile terminal 2 receives settings made by the user and transmits the setting information of the electronic lock 1 set by the user to the electronic lock 1.

Further, the mobile terminal 2 stores the setting information of the electronic lock 1 in the lock setting storage unit 223. Further, the electronic lock 1 stores the setting information of the electronic lock 1 in the lock setting storage unit 121.

Next, the mobile terminal 2 transmits the user ID, the lock ID, and the setting information to the application server 3 (step S213).

Next, the application server 3 transmits the user ID, the lock ID, and the setting information received from the mobile terminal 2 to the management server 6 (step S214). The management server 6 associates the received user ID, lock ID, and setting information with each other and stores them in the management information storage unit 622.

Next, as a log-checking process, first, the mobile terminal 2 transmits a synchronization request to the electronic lock 1 (step S221).

Next, in response to the received synchronization request, the electronic lock 1 transmits the lock ID and the log to the mobile terminal 2 (step S222). The electronic lock 1 transmits the log and lock ID stored in the log storage unit 125 to the mobile terminal 2.

Next, the mobile terminal 2 transmits the user ID, the lock ID, and the log to the application server 3 (step S223). The mobile terminal 2 stores the received lock ID and log in the lock log storage unit 224 and transmits the user ID, the lock ID, and the log to the application server 3.

Next, the application server 3 transmits the user ID, the lock ID, and the log to the management server 6 (step S224). The management server 6 associates the received user ID, lock ID, and log with each other and stores them in the management information storage unit 622.

Next, the application server 3 transmits a report and a proposal to the mobile terminal 2 (step S225). The management application control unit 331 of the application server 3 generates a report and a proposal based on the log and transmits the report and the proposal to the mobile terminal 2 for display.

Next, as an SNS process (content reference process), the mobile terminal 2 transmits the user ID and a reference request to the SNS server 4 (step S231).

Next, the SNS server 4 executes a process of checking reference authority with the management server 6 (step S232).

Next, the SNS server 4 transmits content to the mobile terminal 2 (step S233). The mobile terminal 2 displays the received SNS content (messages or the like).

Furthermore, as the SNS process (posting process), the mobile terminal 2 transmits the user ID and a posting request to the SNS server 4 (step S234).

Next, the SNS server 4 executes a process of checking update authority with the management server 6 (step S235).

Next, the SNS server 4 transmits a posting completion to the mobile terminal 2 (step S236). The mobile terminal 2 executes the posting corresponding to the received posting request on the SNS and transmits a posting completion to the mobile terminal 2.

Next, as a distribution process, the mobile terminal 2 transmits the user ID and the setting information of the electronic lock 1 to the distribution server 5 (step S241). Next, the distribution server 5 transmits additional function information to the mobile terminal 2 (step S242). The distribution server 5 checks the received user ID and setting information of the electronic lock 1, extracts the additional function information, and transmits the extracted information to the mobile terminal 2.

Next, the mobile terminal 2 transmits the user ID and an addition request to the distribution server 5 (step S243). The mobile terminal 2 displays the additional function information received from the distribution server 5 and transmits the user ID and an addition request to the distribution server 5 in response to an operation of an addition request performed by the user.

Next, the distribution server 5 executes a process of checking addition authority with the management server 6 (step S244).

Next, the distribution server 5 transmits an additional function to the mobile terminal 2 (step S245). The distribution server 5 checks the addition authority with the management server 6 and then transmits the additional function corresponding to the addition request to the mobile terminal 2.

Next, the mobile terminal 2 sets the received additional function in the electronic lock 1 (step S246).

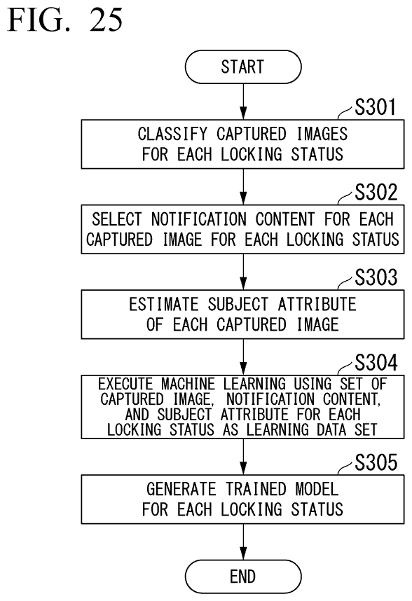

Next, a learning process of the opening/closing control system 100 according to the present embodiment will be described with reference to FIG. 25.

FIG. 25 is a diagram showing an example of a learning process of the opening/closing control system 100 according to the present embodiment. Here, an example in which the management server 6 executes the learning process will be described.

As shown in FIG. 25, the learning processing unit 631 of the management server 6 first classifies the collected captured images for each locking status (step S301). The learning processing unit 631 classifies the collected captured images into the following locking statuses: an unlocked state of the lock unit 14, a state immediately after the lock unit 14 is changed from an unlocked state to a locked state (post-locking state), a locked state of the lock unit 14, and a state immediately after the lock unit 14 is changed from a locked state to an unlocked state (post-unlocking state).

Next, the learning processing unit 631 selects notification content for each captured image for each locked state (step S302). That is, the learning processing unit 631 associates each captured image with notification content.

Next, the learning processing unit 631 estimates a subject attribute of each captured image (step S303). Here, the subject attributes include, for example, attributes such as a toddler, a child, elderly, visually impaired, and hearing impaired.

Next, the learning processing unit 631 executes machine learning using a set of the captured image, the notification content, and the subject attribute for each locked state as learning data (step S304). The learning processing unit 631 stores the generated learning data in the learning information storage unit 621. The learning processing unit 631 executes a learning process of a trained model that determines the notification content through machine learning using the learning data stored in the learning information storage unit 621.

Next, the learning processing unit 631 generates a trained model for each locked state (step S305). The learning processing unit 631 transmits the generated trained model for each locked state to the distribution server 5.

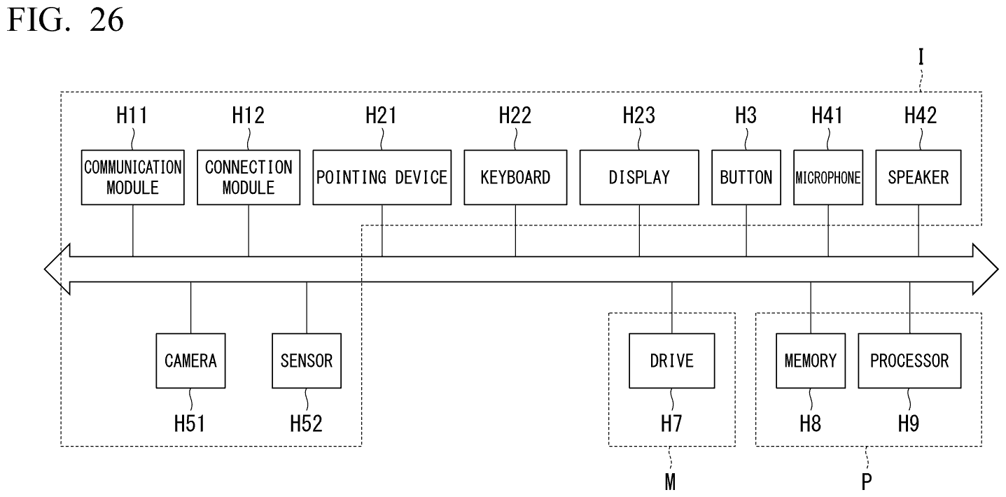

FIG. 26 is an explanatory diagram showing a hardware configuration of each device in the opening/closing control system 100 according to the present embodiment. The devices are a mobile terminal 2, an application server 3, an SNS server 4, a distribution server 5, and a management server 6. Each device includes an input/output module I, a storage module M, and a control module P.

The input/output module I is realized by including some or all of a communication module H11, a connection module H12, a pointing device H21, a keyboard H22, a display H23, a button H3, a microphone H41, a speaker H42, a camera H51, and a sensor H52. The storage module M is realized including a drive H7.

The storage module M may further be configured to include part or all of the memory H8.

The control module Pis realized including a memory H8 and a processor H9. These hardware components are communicatively connected to each other via a bus.

The connection module H12 is a digital input/output port such as a Universal Serial Bus (USB). In the case of a portable device, the pointing device H21, the keyboard H22, and the display H23 are touch panels. The sensor H52 is an acceleration sensor, a gyro sensor, a GPS receiving module, a proximity sensor, or the like. The drive H7 is an auxiliary storage medium, such as a hard disk drive or a solid-state drive. The drive H7 may be a non-volatile memory such as an EEPROM or a flash memory, or a magneto-optical disk drive or a flexible disk drive. Furthermore, the drive H7 is not limited to one built into each device, but may be an external storage device connected to the connector of the connection module H12. The memory H8 is a main storage medium such as a random-access memory. The memory H8 may be a cache memory. The memory H8 stores instructions when these instructions are executed by one or more processors H9. The processor H9 is a central processing unit (CPU). The processor H9 may be a micro processing unit (MPU) or a graphics-processing unit (GPU). The processor H9 reads programs and various types of data from the drive H7 via the memory H8 and performs calculations to execute instructions stored in one or more memories H8.

As described above, the opening/closing control system 100 according to the present embodiment is an opening/closing control system that controls the opening/closing of an opening/closing target and includes a recognition unit 133, a determination unit 134, a lock control unit 136, and an output control unit 135. The recognition unit 133 recognizes an opening/closing person who performs an opening/closing action on an opening/closing target (for example, the refrigerator O1). The determination unit 134 performs a notification determination to determine the notification content and a lock determination to determine unlock control or lock control for the opening/closing target according to the opening/closing person recognized by the recognition unit 133. The lock control unit 136 performs lock control to control unlocking or locking depending on the lock determination. The output control unit 135 performs output control to output a notification to the opening/closing person based on the notification content. That is, the output control unit 135 performs output control to output the notification content to the opening/closing person according to the opening/closing person recognized by the recognition unit 133. In addition, the lock control unit 136 performs lock control to control unlocking or locking of the opening/closing target, according to the opening/closing person recognized by the recognition unit 133.

Accordingly, the opening/closing control system 100 according to the present embodiment determines appropriate notification content, such as advice or a warning, according to the opening/closing person who performs the opening/closing action, outputs the notification to the opening/closing person, and performs lock control to unlock or lock according to the opening/closing person. Therefore, the opening/closing control system 100 according to the present embodiment can appropriately manage an opening/closing action of an opening/closing person while providing appropriate information according to the opening/closing person who performs the opening/closing action.

In addition, in the present embodiment, the determination unit 134 performs a notification determination and a lock determination according to the personality set in association with the opening/closing person. That is, the output control unit 135 performs output control according to the personality set in association with the opening/closing person. In addition, the lock control unit 136 performs lock control according to the personality set in association with the opening/closing person.

Accordingly, the opening/closing control system 100 according to the present embodiment can output, to the opening/closing person, a notification of notification content according to the set personality and can output notification content by an appropriate personality that is tailored to the opening/closing person. Therefore, the opening/closing control system 100 according to the present embodiment can provide more appropriate information according to the opening/closing person.

In addition, in the present embodiment, the notification determination includes a first notification determination to determine the first notification content and a second notification determination to determine the second notification content that is different from the first notification content. In a case where the recognition unit 133 re-recognizes the opening/closing person after the output control unit 135 outputs a notification based on the first notification content, the determination unit 134 performs a second notification determination. The output control unit 135 outputs a notification based on the second notification content.

Accordingly, the opening/closing control system 100 according to the present embodiment can provide more appropriate information according to the opening/closing person, for example, by warning the opening/closing person and then explaining the reason.

In addition, in the present embodiment, the lock determination includes a first lock determination and a second lock determination. The determination unit 134 performs a second lock determination in a case where the recognition unit 133 recognizes the opening/closing person again. The lock control unit 136 performs lock control according to the second lock determination.

Accordingly, the opening/closing control system 100 according to the present embodiment can perform flexible lock determinations according to the situation, for example, by first performing a lock determination to keep the door unlocked and then performing a lock determination to lock the door, thereby enabling more appropriate management of the opening/closing actions of the opening/closing person.

In addition, in the present embodiment, the determination unit 134 performs a second lock determination and a second notification determination based on the re-recognized opening/closing person and the result of the first notification determination.

Accordingly, the opening/closing control system 100 according to the present embodiment can, for example, after issuing a warning once, further perform a lock determination and a notification determination depending on the content of the warning issued by the opening/closing person and their behavior after the warning, thereby performing flexible determinations according to the situation.

In addition, in the present embodiment, the determination unit 134 performs a second lock determination and a second notification determination depending on the position of the re-recognized opening/closing person.

Accordingly, the opening/closing control system 100 according to the present embodiment can further perform a lock determination and a notification determination, for example, in a case where the opening/closing person approaches an opening/closing target after issuing a warning once, thereby performing flexible determinations according to the situation.

In addition, in the present embodiment, in a case where the opening/closing target is in an unlocked state, the determination unit 134 determines whether or not to perform lock control as a lock determination. In a case where it is determined that lock control is to be performed, the lock control unit 136 changes a state of the opening/closing target from an unlocked state to a locked state. Furthermore, in a case where the opening/closing target is in a locked state, the determination unit 134 determines whether or not to perform unlock control as a lock determination depending on whether or not an unlocking condition is satisfied. In a case where it is determined that unlock control is to be performed, the lock control unit 136 changes a state of the opening/closing target from a locked state to an unlocked state.

Accordingly, the opening/closing control system 100 according to the present embodiment can appropriately perform a lock determination by distinguishing between a case where the opening/closing target is in an unlocked state and a case where the opening/closing target is in a locked state and can flexibly change the lock control according to the locking status of the opening/closing target.

In addition, the opening/closing control system 100 according to the present embodiment includes the model storage unit 123 configured to store a trained model that is trained for each locking status of the opening/closing target and that determines the notification content for each locking status of the opening/closing target. The determination unit 134 performs a notification determination for each locking status of the opening/closing target based on the trained model stored in the model storage unit 123.

Accordingly, the opening/closing control system 100 according to the present embodiment can flexibly change the notification content for each locking status of the opening/closing target and can provide more appropriate information according to the locking status of the opening/closing target.

In addition, the opening/closing control system 100 according to the present embodiment includes the learning processing unit 631 configured to generate the trained model through machine learning for each locking status of the opening/closing target.

Accordingly, the opening/closing control system 100 according to the present embodiment can flexibly change the notification content for each locking status of the opening/closing target and can generate a trained model, thereby enabling it to flexibly respond to changes in the situation.

In addition, in the present embodiment, the determination unit 134 performs a lock determination according to the position where the recognized opening/closing person touched the opening/closing target, the approach speed of the opening/closing person, or the date and time information when the opening/closing person is recognized. That is, the lock control unit 136 performs lock control according to the position where the recognized opening/closing person touched the opening/closing target, the approach speed of the opening/closing person, or the date and time information when the opening/closing person is recognized.

Accordingly, the opening/closing control system 100 according to the present embodiment can perform lock control more flexibly and appropriately according to the actions of the opening/closing person or circumstances such as the date and time (day of the week or time period).

In addition, in the present embodiment, the determination unit 134 determines the notification content to deter or warn about the opening/closing action according to the recognized opening/closing person. That is, the output control unit 135 outputs a notification content to deter or warn about the opening/closing action according to the recognized opening/closing person.

Accordingly, the opening/closing control system 100 according to the present embodiment can appropriately manage the opening/closing action of an opening/closing person from the viewpoint of danger avoidance, education, or behavioral restraint, for example, in a case where the opening/closing person is a toddler, a child, or an alcoholic.

In addition, in the present embodiment, the determination unit 134 determines the notification content according to the opening/closing target or the contents held in the opening/closing target. That is, the output control unit 135 outputs notification content according to the opening/closing target or the contents held in the opening/closing target.

Accordingly, the opening/closing control system 100 according to the present embodiment can, for example, change the notification content for a child or a toddler depending on whether or not ice cream is among the contents held in a refrigerator O1 in a case where the opening/closing target is the refrigerator O1. In other words, the opening/closing control system 100 according to the present embodiment can appropriately and flexibly change the notification content according to the opening/closing target or the contents held in the opening/closing target.

In addition, in the present embodiment, the determination unit 134 determines whether or not to perform a notification determination or a lock determination according to the recognized opening/closing person.

Accordingly, the opening/closing control system 100 according to the present embodiment can perform flexible determinations according to the situation, such as not performing a notification determination or a lock determination, for example, in a case where the opening/closing person is an adult.

In addition, in the present embodiment, the determination unit 134 determines the notification content according to the status of the opening/closing action for the opening/closing target. That is, the output control unit 135 outputs notification content according to the status of the opening/closing action for the opening/closing target.

Accordingly, the opening/closing control system 100 according to the present embodiment can output an appropriate notification (reminding), such as issuing a warning, for example, in a case where the refrigerator O1 is closed roughly, and can perform flexible notification determinations according to the situation.

In addition, the electronic lock 1 (the opening/closing device) according to the present embodiment is an opening/closing device that controls the opening/closing of an opening/closing target and includes a recognition unit 133, a determination unit 134, a lock control unit 136, and an output control unit 135. The recognition unit 133 recognizes an opening/closing person who performs an opening/closing action on an opening/closing target (for example, the refrigerator O1). The determination unit 134 performs a notification determination to determine the notification content and a lock determination to determine unlock control or lock control for the opening/closing target according to the opening/closing person recognized by the recognition unit 133. The lock control unit 136 performs lock control to control unlocking or locking depending on the lock determination. The output control unit 135 performs output control to output a notification to the opening/closing person based on the notification content. That is, the output control unit 135 performs output control to output the notification content to the opening/closing person according to the opening/closing person recognized by the recognition unit 133. In addition, the lock control unit 136 performs lock control to control unlocking or locking of the opening/closing target, according to the opening/closing person recognized by the recognition unit 133.

Accordingly, the electronic lock 1 according to the present embodiment has the same effect as the opening/closing control system 100 described above and can appropriately manage an opening/closing action of an opening/closing person while providing appropriate information according to the opening/closing person who performs the opening/closing action.

Further, the opening/closing control method according to the present embodiment is an opening/closing control method for the opening/closing control system 100 that controls the opening/closing of an opening/closing target, and includes a recognition step, a determination step, a lock control step, and an output control step. In the recognition step, the recognition unit 133 recognizes an opening/closing person who performs an opening/closing action on an opening/closing target. In the determination step, the determination unit 134 performs a notification determination to determine the notification content and a lock determination to determine unlock control or lock control for the opening/closing target according to the opening/closing person recognized by the recognition unit 133. In the lock control step, the lock control unit 136 performs lock control to control unlocking or locking depending on the lock determination. In the output control step, the output control unit 135 performs output control to output a notification to the opening/closing person based on the notification content. That is, in the output control step, the output control unit 135 performs output control to output the notification content to the opening/closing person according to the opening/closing person recognized by the recognition unit 133. In addition, in the lock control step, the lock control unit 136 performs lock control to control unlocking or locking of the opening/closing target, according to the opening/closing person recognized by the recognition unit 133.

Accordingly, the opening/closing control method according to the present embodiment has the same effect as the opening/closing control system 100 described above and can appropriately manage an opening/closing action of an opening/closing person while providing appropriate information according to the opening/closing person who performs the opening/closing action.

The present disclosure is not limited to the above-described embodiment and can be modified without departing from the spirit and scope of the present disclosure.

For example, in the above embodiment, an example has been described in which the electronic lock 1 is equipped with a recognition unit 133, a determination unit 134, a lock control unit 136, and an output control unit 135, but the present disclosure is not limited thereto. Some or all of the recognition unit 133, the determination unit 134, the lock control unit 136, and the output control unit 135 may be provided outside the electronic lock 1. For example, the electronic lock 1 may be capable of communicating with the application server 3, the SNS server 4, the distribution server 5, and the management server 6 without going through the mobile terminal 2, and some or all of the recognition unit 133, the determination unit 134, the lock control unit 136, and the output control unit 135 may be provided by any of the application server 3, the SNS server 4, the distribution server 5, and the management server 6. In other words, the electronic lock 1 may be configured to connect directly to the network NW without going through the mobile terminal 2. In addition, in the case of transmitting and receiving data, the electronic lock 1 connects directly to the network NW, but the electronic lock 1 may be set or viewed via the mobile terminal 2.

In addition, in the above embodiment, an example has been described in which the application server 3, the SNS server 4, the distribution server 5, and the management server 6 are each different server devices, but the present disclosure is not limited thereto, and some or all of the application server 3, the SNS server 4, the distribution server 5, and the management server 6 may be configured as a single server device.

In addition, in the above embodiment, an example has been described in which the opening/closing target on which the electronic lock 1 is installed is a refrigerator O1, but the present disclosure is not limited thereto, and the opening/closing target may be, for example, a home appliance such as a rice cooker, microwave oven, oven, or remote control (television, air conditioner), or furniture such as a shelf, drawer, or safe. The opening/closing target may be a door or window of a shared house, hospital, childcare facility, balcony, room, bathroom, toilet, and the like or may be home equipment such as a stove, bath, or underfloor heating. The opening/closing target may be a vehicle such as a car, a motorcycle, or a bicycle.

In the above embodiment, in a case where the recognition unit 133 recognizes a plurality of opening/closing persons, for example, the youngest person may be recognized as the opening/closing person. Furthermore, in a case where the recognition unit 133 recognizes a plurality of opening/closing persons, the recognition unit 133 may recognize one opening/closing person according to, for example, a positional relationship with the opening/closing target or the action of the opening/closing person. The recognition unit 133 may preferentially recognize as an opening/closing person, for example, a person who is close to the opening/closing target or a person who has stopped near the opening/closing target.

In addition, in the above embodiment, an example has been described in which the management server 6 executes the learning process, but the present disclosure is not limited thereto, and other devices (for example, the electronic lock 1, the mobile terminal 2, the application server 3, the SNS server 4, the distribution server 5, and the like) may execute the learning process. In other words, other devices (for example, the electronic lock 1, the mobile terminal 2, the application server 3, the SNS server 4, the distribution server 5, and the like) may include the learning processing unit 631 instead of the management server 6.

In addition, in the above embodiment, an example has been described in which the notification content is output to the opening/closing person by voice, but the present disclosure is not limited thereto, and a message may be displayed on the display unit, or a combination of voice and display may be output to the opening/closing person.

In the above embodiment, the notification content output to the opening/closing person may be configured such that the notification timing (output timing) or the lock control timing can be set according to the opening/closing target.

In addition, the electronic lock 1 may be configured to determine whether or not to perform a notification determination or a lock determination depending on date and time information (day of the week or time period). In other words, the electronic lock 1 may be configured not to perform a notification determination or a lock determination, for example, during time periods when children are not present or on days of the week when parents are present.

In addition, the electronic lock 1 (the determination unit 134) may determine the notification content depending on how the lock is opened or closed. The electronic lock 1 may, for example, provide a function to warn users about how to close the door in a case where it is closed improperly or to warn users about how to close the door in a case where it is closed with their foot, and the like.

In addition, the electronic lock 1 (the determination unit 134) may determine whether or not to give a notification depending on the attributes of the opening/closing person. For example, no notification may be given to adults, and a strict warning may be given to children.

In addition, the electronic lock 1 (the output control unit 135) may change the volume of the sound at which the notification is output depending on the opening/closing person or the notification content. For example, the output control unit 135 may increase the volume of the sound in a case where a warning is required and return the volume of the sound to normal in a case where education is required. In addition, the electronic lock 1 (the output control unit 135) may increase the volume of the sound in the case of calling people nearby.

In addition, the electronic lock 1 (output control unit 135) may change the speaking speed, tone, demeanor, etc. depending on the notification content. For example, the output control unit 135 may increase the speed of speech in a case where a warning is required and speak slowly in a case where education is required. For example, the output control unit 135 may output in a high tone in a case where a warning is required and output in a low tone in a case where education is required.

In the above embodiment, the opening/closing person for a notification determination may be set to, for example, a child, a person on a diet, a person being cared for, or a specific person.

In addition, the electronic lock 1 may be set to change the voice owner that gives the notification (speaks) depending on the opening/closing person or to perform a notification determination according to the type of care provided.

In addition, the electronic lock 1 may be set according to the opening/closing target, and the notification content may be set to notifications that represent human sensations such as hot, cold, pain, and the like.

In addition, in the above embodiment, an example has been described in which the electronic lock 1 is configured to be attachable and detachable to and from the opening/closing target (for example, refrigerator O1), but the present disclosure is not limited thereto and the electronic lock 1 may be built into the opening/closing target.

In addition, the electronic lock 1 may be configured to be in an unlocked state in a case where it is removed from the opening/closing target. In addition, the electronic lock 1 may be configured to be in an unlocked state when the battery is being charged, when the battery is removed, and the like.

In addition, in the above embodiment, an example has been described in which the electronic lock 1 controls unlocking and locking, but the present disclosure is not limited thereto. For example, an actuator or the like may be provided in the opening/closing part to increase the force required for opening/closing and control the opening/closing slowly.

In the above embodiment, an example has been described in which the voice, model, scenario, and the like are downloaded from the distribution server 5, but a charge may be made at the time of downloading.

In addition, in the above embodiment, the electronic lock 1 may be configured to set the notification content to be a simple question in English for language learning, a simple question for learning general knowledge, or an explanation. The electronic lock 1 may display, for example, “Notice for What day it is today (a family member's birthday or a home visit or school open day, and the like)” or “the weather forecast”.

In addition, in the above embodiment, an example has been described in which sensing information is included in the conditions for recognizing the opening/closing person or for the notification determination and the lock determination. However, a sensor may be provided on a door or a handle that is an opening/closing target, and an opening/closing person may be recognized, or a notification determination and a lock determination may be performed depending on the position touched by the opening/closing person. For example, a condition for recognizing a child as the opening/closing person may be that the position touched by the opening/closing person is lower than a specific position.

In addition, among the conditions shown in FIG. 5 and FIG. 6, the number of notifications or the number of locking/unlocking operations made to the same detection subject within a specific period may be included as one of the conditions for changing the notification content or whether or not to lock. In other words, for example, it is necessary to properly educate a toddler or the like the first time, but in a case where improvement in behavior is seen after multiple times, it is thought that educational notifications are not necessary or that education using different notification content would be effective. Therefore, the electronic lock 1 may change the notification content or whether or not to lock depending on the number of notifications or the number of locking/unlocking operations based on scenario information.

In addition, while FIG. 5 above shows an example in which the scenario information outputs notification content before and after locking, the present disclosure is not necessarily limited thereto, and the scenario information may output notification content only either before locking or after locking. In this case, it is preferable that the electronic lock 1 be locked before outputting the notification content, for example, in consideration of the safety of toddlers (preschoolers). Alternatively, the electronic lock 1 may determine whether or not to give a notification at a timing before or after locking according to the type of notification content to be output or the recognized opening/closing person.

In the opening/closing control system 100 according to the above embodiment, the opening/closing target may be a shared trash can provided in a shared housing complex such as a condominium, or the door of a trash dump site managed by a ward, city, town, or village. In this case, the electronic lock 1 may be set to only be unlocked on designated dates or during designated time periods, such as on days for collecting burnable garbage, or may be set to be unlocked only by the intended resident or caretaker.

In addition, in the opening/closing control system 100 according to the above embodiment, for example, in a case where an alcoholic takes out alcohol from the refrigerator O1 or a shelf that is the opening/closing target, a notification may be sent to an administrator such as a psychological surgeon/psychological counselor.

In addition, as an optional contract or a billing service, if an alcoholic manages to refrain from alcohol, for example, the psychological surgeon/psychological counselor may notify the target person of a praising comment, or the date, time, or number of drinks consumed may be digitized and notified to the psychological surgeon/psychological counselor. In this case, the psychological surgeon/psychological counselor can also effectively utilize the data and appropriately manage the opening/closing action of the opening/closing person (alcoholic).

Each component of the opening/closing control system 100 and the electronic lock 1 described above has an internal computer system. Then, a program for realizing the functions of each component of the above-mentioned opening/closing control system 100 and electronic lock 1 can be recorded on a computer-readable recording medium, and the program recorded on this recording medium can be read into a computer system and executed to perform processing in each component of the above-mentioned opening/closing control system 100 and electronic lock 1. Here, “reading a program recorded on a recording medium into a computer system and executing it” includes installing the program into the computer system. Here, the “computer system” mentioned here includes an operating system (OS) and hardware such as a peripheral device.

Furthermore, the “computer system” may include a plurality of computer devices connected via a network including a communication line such as the Internet, a WAN, a LAN, and a dedicated line. In addition, the “computer-readable recording medium” refers to a portable medium such as a flexible disk, a magneto-optical disk, a ROM, or a CD-ROM or a storage device such as a hard disk that is built into the computer system. In this way, the recording medium on which the program is stored may be a non-transitory recording medium such as a CD-ROM.

The recording medium also includes an internal or external recording medium that is accessible by a distribution server to distribute the program. In addition, the program may be divided into a plurality of parts, each of which may be downloaded at a different timing and then combined into each component of the opening/closing control system 100 and the electronic lock 1, or each of the divided programs may be distributed by a different distribution server. Further, the “computer-readable recording medium” also includes a medium that holds the program for a certain period of time, such as a volatile memory (RAM) inside the computer system that serves as a server or a client in a case where the program is transmitted via a network. Moreover, the above-mentioned program may be a program for realizing some of the above-mentioned functions. Furthermore, the program may be a so-called difference file (difference program) that can realize the above-described functions in combination with a program already recorded in the computer system.

### REFERENCE SIGNS LIST

1, 1-1, 1-1a, 1-1b, 1-1c Electronic lock
2 Mobile terminal
3 Application server
4 SNS server
5 Distribution server
6 Management server
14 Lock unit
15 Power supply
100 Opening/closing control system
111, 211, 311, 411, 511, 611 Communication unit
112, 214 Imaging unit
113, 213 Output unit
121 Lock setting storage unit
122 Scenario storage unit
123 Model storage unit
124 Collected information storage unit
125 log storage unit
131 Setting update unit
132 Information collection unit
133 Recognition unit
134 Determination unit
135 Output control unit
136 Lock control unit
141 Plate
142 Rotating shaft
143 Protrusion
144 Lock bolt
145 Drive unit
212 Input unit
215 Sensor unit
221 Application storage unit
222 User information storage unit
223 Lock setting storage unit
224 Lock log storage unit
231 Application control unit
232 User information management unit
233 Lock setting unit
234 Lock log acquisition unit
235 Display control unit
321 Management application storage unit
331 Management application control unit
421 SNS information storage unit
431 SNS control unit
521 Distribution information storage unit
531 Distribution control unit
621 Learning information storage unit
622 Management information storage unit
631 Learning processing unit
632 Management control unit
11, 12, 13, 14, 15, 16 Input/output module
M1, M2, M3, M4, M5, M6 Memory
P1, P2, P3, P4, P5, P6 Processor
O1 Refrigerator

1.-18. (canceled)

19. An opening/closing control system to control opening/closing of an opening/closing target, the opening/closing control system comprising a processor to:
recognize an opening/closing person who performs an opening/closing action on the opening/closing target;
perform output control to output notification content to the opening/closing person according to the opening/closing person;
perform lock control to control unlocking or locking of the opening/closing target according to the opening/closing person;
perform the output control based on the notification content according to a personality of the opening/closing target or a lock, the personality being set in association with the opening/closing person; and
perform the lock control according to the personality.

20. An opening/closing control system to control opening/closing of an opening/closing target, the opening/closing control system comprising a processor to:
recognize an opening/closing person who performs an opening/closing action on the opening/closing target;
perform output control to output notification content to the opening/closing person according to the opening/closing person;
perform lock control to control unlocking or locking of the opening/closing target according to the opening/closing person;
perform a notification determination to determine the notification content and a lock determination to determine unlock control or lock control for the opening/closing target according to the opening/closing person, the notification determination including a first notification determination to determine first notification content and a second notification determination to determine second notification content different from the first notification content;
perform the output control based on the notification determination;
perform the lock control according to the lock determination;
perform the second notification determination in a case where the processor re-recognizes the opening/closing person after outputting a notification based on the first notification content; and
output a notification based on the second notification content.

21. The opening/closing control system according to claim 20,
wherein the lock determination includes a first lock determination and a second lock determination,
wherein the processor performs the second lock determination in a case where the processor re-recognizes the opening/closing person, and
wherein the processor performs the lock control according to the second lock determination.

22. The opening/closing control system according to claim 21,
wherein the processor performs the second lock determination and the second notification determination based on the re-recognized opening/closing person and a result of the first notification determination.

23. The opening/closing control system according to claim 21,
wherein the processor performs the second lock determination and the second notification determination according to a position of the re-recognized opening/closing person.

24. The opening/closing control system according to any one of claim 20,
wherein the processor determines whether or not to perform the lock control as the lock determination in a case where the opening/closing target is in an unlocked state, and
wherein the processor changes a state of the opening/closing target from the unlocked state to a locked state in a case where it is determined that the lock control is to be performed.

25. The opening/closing control system according to claim 24,
wherein the processor determines whether or not to perform the unlock control as the lock determination depending on whether or not an unlocking condition is satisfied in a case where the opening/closing target is in the locked state, and
wherein the processor changes the state of the opening/closing target from the locked state to the unlocked state in a case where it is determined that the unlock control is to be performed.

26. An opening/closing control system to control opening/closing of an opening/closing target, the opening/closing control system comprising a processor to:
recognize an opening/closing person who performs an opening/closing action on the opening/closing target;
perform output control to output notification content to the opening/closing person according to the opening/closing person;
perform lock control to control unlocking or locking of the opening/closing target according to the opening/closing person;
perform a notification determination to determine the notification content and a lock determination to determine unlock control or lock control for the opening/closing target according to the opening/closing person;
store in a storage medium a trained model that is trained for each locking status of the opening/closing target and that determines the notification content for each locking status of the opening/closing target;
perform the output control based on the notification determination;
perform the lock control according to the lock determination; and
perform the notification determination for each locking status of the opening/closing target based on the trained model stored in the storage medium.

27. The opening/closing control system according to claim 26, wherein the processor generates the trained model through machine learning for each locking status of the opening/closing target.

28. The opening/closing control system according to claim 19, further comprising a lock to perform the unlocking or the locking on the opening/closing target,
wherein at least one of the lock and a battery that supplies power to the lock is attachable and detachable.

29. The opening/closing control system according to claim 28,
wherein the lock, which is attachable and detachable, includes an image sensor to perform imaging for recognizing the opening/closing person.

30. The opening/closing control system according to claim 28,
wherein the lock is in an unlocked state when the battery is attached and detached.

31. The opening/closing control system according to claim 19,
wherein the processor outputs the notification content for encouraging the opening/closing person to improve their behavior according to a usage status of the opening/closing person.

32. The opening/closing control system according to claim 20,
wherein the processor determines whether or not to perform the notification determination or the lock determination according to the recognized opening/closing person.

33. The opening/closing control system according to claim 19,
wherein the processor performs the lock control according to a position where the recognized opening/closing person touches the opening/closing target, an approach speed of the opening/closing person, or date and time information when the opening/closing person is recognized.

34. The opening/closing control system according to claim 19,
wherein the processor outputs the notification content to deter or warn about the opening/closing action according to the recognized opening/closing person.

35. The opening/closing control system according to claim 19,
wherein the processor outputs the notification content according to the opening/closing target or contents held in the opening/closing target.

36. The opening/closing control system according to claim 19,
wherein the processor outputs the notification content according to a status of the opening/closing action for the opening/closing target.

37. An opening/closing device to control opening/closing of an opening/closing target, the opening/closing device comprising a processor to:
recognize an opening/closing person who performs an opening/closing action on the opening/closing target;
perform output control to output notification content to the opening/closing person according to the recognized opening/closing person;
perform lock control to control unlocking or locking of the opening/closing target according to the recognized opening/closing person;
perform the output control based on the notification content according to a personality of the opening/closing target or a lock, the personality being set in association with the opening/closing person; and
perform the lock control according to the personality.

38. An opening/closing control device to control opening/closing of an opening/closing target, the opening/closing device comprising a processor to:
recognize an opening/closing person who performs an opening/closing action on the opening/closing target;
perform output control to output notification content to the opening/closing person according to the opening/closing person;
perform lock control to control unlocking or locking of the opening/closing target according to the opening/closing person;
perform a notification determination to determine the notification content and a lock determination to determine unlock control or lock control for the opening/closing target according to the opening/closing person, the notification determination including a first notification determination to determine first notification content and a second notification determination to determine second notification content different from the first notification content;
perform the output control based on the notification determination;
perform the lock control according to the lock determination;
perform the second notification determination in a case where the processor re-recognizes the opening/closing person after outputting a notification based on the first notification content; and
output a notification based on the second notification content.

39. An opening/closing control device to control opening/closing of an opening/closing target, the opening/closing device comprising a processor to:
recognize an opening/closing person who performs an opening/closing action on the opening/closing target;
perform output control to output notification content to the opening/closing person according to the opening/closing person;
perform lock control to control unlocking or locking of the opening/closing target according to the opening/closing person;
perform a notification determination to determine the notification content and a lock determination to determine unlock control or lock control for the opening/closing target according to the opening/closing person;
store in a storage medium a trained model that is trained for each locking status of the opening/closing target and that determines the notification content for each locking status of the opening/closing target;
perform the output control based on the notification determination;
perform the lock control according to the lock determination; and
perform the notification determination for each locking status of the opening/closing target based on the trained model stored in the storage medium.

40. An opening/closing control method for an opening/closing control system to control opening/closing of an opening/closing target, the opening/closing control method comprising:
recognizing an opening/closing person who performs an opening/closing action on the opening/closing target;
performing output control to output notification content to the opening/closing person according to the opening/closing person; and
performing lock control to control unlocking or locking of the opening/closing target according to the opening/closing person;
perform the output control based on the notification content according to a personality of the opening/closing target or a lock, the personality being set in association with the opening/closing person; and
perform the lock control according to the personality.

41. An opening/closing control method for an opening/closing control system to control opening/closing of an opening/closing target, the opening/closing control method comprising:
recognizing an opening/closing person who performs an opening/closing action on the opening/closing target;
performing output control to output notification content to the opening/closing person according to the opening/closing person; and
performing lock control to control unlocking or locking of the opening/closing target according to the opening/closing person;
performing a notification determination to decide the notification content and a lock determination to determine unlock control or lock control for the opening/closing target according to the opening/closing person, the notification determination including a first notification determination to decide first notification content and a second notification determination to decide second notification content different from the first notification content;
performing the output control based on the notification determination;
performing the lock control according to the lock determination;
performing the second notification determination in a case where the processor re-recognizes the opening/closing person after outputting a notification based on the first notification content; and
outputting a notification based on the second notification content.

42. An opening/closing control method for an opening/closing control system to control opening/closing of an opening/closing target, the opening/closing control system including a storage medium to store a trained model that is trained for each locking status of the opening/closing target and that decides notification content for each locking status of the opening/closing target, the opening/closing control method comprising:
recognizing an opening/closing person who performs an opening/closing action on the opening/closing target;
performing output control to output the notification content to the opening/closing person according to the opening/closing person; and
performing lock control to control unlocking or locking of the opening/closing target according to the opening/closing person;
performing a notification determination to decide the notification content and a lock determination to determine unlock control or lock control for the opening/closing target according to the opening/closing person;
performing the output control based on the notification determination;
performing the lock control according to the lock determination; and
performing the notification determination for each locking status of the opening/closing target based on the trained model stored in the storage medium.
